(19) United States
(12) Patent Application Publication
(10) Pub. No.: US 2026/0199811 A1
(43) Pub. Date: Jul. 16, 2026

(54) VARIABLE HEIGHT, OFFSET, ANGLED & BRIDGED EMBOSSMENT

(71) Applicants: Parker-Hannifin Corporation, Cleveland, OH (US); Baldwin Filters, Inc., Cleveland, OH (US)

(72) Inventors: Joshua W. Witte, Kearney, NE (US); Charles R. Wick, Pleasanton, NE (US); Levi W. Dexter, Elm Creek, NE (US); Erik R. Bower, Kearney, NE (US); Brian T. Ehrenberg, Kansas City, MO (US); Timothy L. Krull, Kearney, NE (US)

(73) Assignees: Parker-Hannifin Corporation, Cleveland, OH (US); Baldwin Filters, Inc., Cleveland, OH (US)

(21) Appl. No.: 19/562,323

(22) Filed: Mar. 10, 2026

Related U.S. Application Data
(63) Continuation of application No. PCT/US2024/044109, filed on Aug. 28, 2024.
(60) Provisional application No. 63/540,728, filed on Sep. 27, 2023.
(60) Provisional application No. 63/622,958, filed on Jan. 19, 2024.

(51) Int. Cl. B01D 29/07; B01D 46/10; B01D 46/52

(52) U.S. Cl. CPC B01D 29/07; B01D 46/10; B01D 46/523; B01D 2201/127

(57) ABSTRACT

A pleated filter media pack comprises a filter media sheet folded along pleat folds to provide a plurality of pleats with panels. A plurality of elongated embossments formed into the filter media sheet that separated laterally by un-embossed/flat regions. At least one feature provides any one or more of the following: bridge strength laterally between the elongated embossments, panel/embossment rigidity, or intermittent contact points. Such feature can comprise any one or more of the following: variable height embossments with saddles formed into the embossments; offset alignment of the elongated embossments; bridge embossments formed into the un-embossed/flat regions; or angled alignment of the elongated embossments.

### CROSS-REFERENCE TO RELATED PATENT APPLICATIONS

This Patent Application is a Continuation of PCT Patent Application No. PCT/US2024/044109, filed Aug. 28, 2024, which is currently pending, the entire teachings and disclosure of which are incorporated herein by reference thereto. This Patent Application claims the benefit of U.S. Provisional Patent Application No. 63/622,958, filed Jan. 19, 2024, and U.S. Provisional Patent Application No. 63/540,728, filed Sep. 27, 2023, the entire teachings and disclosure each of which are incorporated herein by reference thereto.

### FIELD OF THE INVENTION

The disclosure relates to feature enhancements for use in connection with embossments for filter media.

### BACKGROUND OF THE INVENTION

Examples of current embossments are shown in U.S. Patent Publication No. US2022/0096985A1 to Tate et al. entitled FILTER MEDIA PACKS, METHODS OF MAKING AND FILTER MEDIA PRESSES, the entire disclosure of which is hereby incorporated by reference. Additional embossing patterns are shown in US2021/0229021A to Copley et al., entitled PLEATED CHANNEL FLOW FILTER AND/OR ROLL FORM METHOD, however this design requires sealing inlet and outlet ends of the filter media sheet. Yet a further emboss pattern in a pleated filter element is shown in U.S. Pat. No. 7,425,227 B1 to Hutchison et al. entitled PLEATED FILTER ELEMENT WITH OFFSET EMBOSS PATTERN. The '227 patent discloses a pleated filter media with a plurality of pleats having peaks and valleys with arrays of elongated embossments projecting from both the clean and dirty sides thereof, and elongated embossments are positioned so that the elongated embossments embossed on adjacent pleats of the filter media are offset from each other in a direction parallel to the peaks and valleys.

Current embossment design in filter media is susceptible to blinding off against the next sheet along the length of the embossment, rendering this media less effective. Also, current embossment designs are not as effective and prone to relaxing with certain types of filter medias.

### BRIEF SUMMARY OF THE INVENTION

Various embossment improvements described herein better maintain or open up space for this media to remove contaminant and allow additional airflow. Additionally, opening space between the embossment tip and flat sheet can enable air flow to spread past embossment channels to improve air flow and media usage.

The present disclosure relates to improvements on embossing patterns with one or more embossing enhancement features that can take various forms, which may be used individually or in various combination with each other.

In a first embodiment, variable height embossments in the form of elongated ridges or channels extend across the filter media, provide structure to the media, reduce blinding-off of the media and prevent relaxing of the embossments perpendicular to the direction of embossments. In another embodiment, offset embossments add structure to the pack by shortening the “beam” to prevent pack collapse under high differential pressure. In a third embodiment, embossment support bridges add structure to the un-embossed/flat section between embossments, support the pack against collapse under high differential pressure, and reduce blinding-off of media. In yet another fourth embodiment, angled embossments reduce blinding-off of media, can facilitate a continuous embossing process, and can allow for customization of pleat height without significant tooling changes. Additionally, speculative effects of turbulent air flow created from alternating flow paths could create a scavenging effect within the media pack to distribute contaminant more evenly throughout the media. Further, various additional embodiments involve different combinations of any two or more of these four embodiments of embossing enhancement features.

The subject improvements provide structure to the embossments and media pack. For example, cellulose media tends to relax, or partially return to its original flat sheet form. Although these improvements are useful for medias that are not primarily cellulose, the improvements are particularly useful and beneficial for medias that are primarily if not mostly cellulose fibers. The various embossment improvements help to support the embossments against relaxing. These improvements also promote overall pack structure during high flow. These geometric improvements can be used individually or in combination with one or more of the embodiments, and are made without the use of adhesives, which has commonly been used to solve this problem.

According to an inventive aspect, a pleated filter media pack comprises a filter media sheet folded along pleat folds at an inlet flow face and pleat folds at an outlet flow face to provide a plurality of pleats with panels extending between the inlet flow face and the outlet flow face. A plurality of elongated embossments are formed into the filter media sheet and extend longitudinally between the inlet flow face and the outlet flow face. The elongated embossments are spaced laterally apart and separated laterally by un-embossed/flat regions. The filter media pack further comprise at least one feature. Such at least one feature comprises any one or more of the following: (a) saddles formed into the elongated embossments that are raised relative to the un-embossed/flat regions; or (b) offset alignment of the elongated embossments comprising a first set of the elongated embossments of first panels, and a second set of the elongated embossments of second panels that project in a common direction as the first set, wherein the first set of the elongated embossments engage respective regions of the un-embossed/flat regions of the second panels at a location offset from a lateral midpoint defined between respective adjacent embossments of the respective regions of the un-embossed/flat regions of the second panels; or (c) bridge embossments formed into the un-embossed/flat regions that extend laterally between adjacent members of the elongated embossments; or (d) angled alignment of the elongated embossments, wherein the elongated embossments extend at an oblique angle relative to the pleat folds and with intermittent contact locations.

Such at least one feature (may also be considered an embossment enhancement) that can provide any one or more of the following: (a) bridge strength laterally between the elongated embossments, (b) panel/embossment rigidity or (c) intermittent contact points.

Various additional aspects and features may be used with the inventive aspect, either individually or in combination(s) with each other as detailed in the following paragraphs.

Additional Optional Features Usable in the Filter Media Pack with any of the Embossment Enhancement Feature(s)

It is a feature that the elongated embossments can extend between 75% and 99% of a span of the panels between the inlet flow face and the outlet flow face, and more preferably between 95% and 99% of a span of the panels between the inlet flow face and the outlet flow face.

It is a feature that creasing regions can extend transversely between opposed edges of the filter media sheet. The creasing regions have a width parallel to the opposed edges spanning between 0.1 and 3.0 centimeter, more preferably between 0.2 and 1.0 centimeter. Further, at least one score line is formed in each creasing region thereby to facilitate the pleat folds; and the elongated embossments reside outside of the creasing regions and taper toward the creasing regions at opposite ends of the elongated embossments.

It is a feature that all of the elongated embossments can extend continuously an entire span between the creasing regions at opposite ends of the elongated embossments.

It is a feature that the inventive aspect can be used in deeper filter media packs, wherein the panels extend a span between the inlet flow face and the outlet flow face between 7 and 45 centimeters, more preferably between 10 and 35 centimeters.

In the inventive aspect, the filter media sheet can comprise cellulose fibers, synthetic polymer fibers, or glass fibers.

It is a feature that the filter media sheet can comprise a blend of fibers comprising the cellulose fibers and the synthetic polymer fibers, wherein the blend of fibers comprises by weight percentage greater than 50% cellulose fibers; and more preferably between 70%-90% cellulose fibers and 10%-30% synthetic polymer fibers; and most preferably between 75%-85% cellulose fibers and 15%-25% synthetic polymer fibers.

It is a feature that no adhesives may be applied internally of the pleated filter media pack between panels of the filter media sheet.

It is a feature that the elongated embossments can comprise a maximum depth of between 1.0 and 4.5 millimeters, more preferably between 1.0 and 2.0 millimeters, and most preferably between 1.3 and 1.6 millimeters.

It is a feature that within an internal region of the pleated filter media pack, the lateral span of the un-embossed/flat regions can be at least 200%, more preferably between 200% and 600%, and most preferably between 225% and 325% of the lateral span of each of the elongated embossments.

It is a feature in some embodiments that all of the elongated embossments can face the same direction in the pleated filter media pack, with the pleated filter media pack having successively alternating first and second panels. With this feature, the elongated embossments on first panels projects outwardly from a first side face of the filter media sheet, and the elongated embossments on second panels project outwardly from a second side face of the filter media sheet opposite the first side face.

It is a feature that the at least one feature (e.g., embossment enhancement feature) can provide both bridge strength laterally between embossments and intermittent contact points.

It is a feature according to some embodiments that the at least one feature (e.g., embossment enhancement feature) can comprise at least two features selected from the following group: (a) the saddles, (b) the offset alignment, and (c) the bridge embossments.

It is a feature according to some embodiments that the at least one feature (e.g., embossment enhancement feature) can comprise all of: (a) the saddles, (b) the offset alignment, and (c) the bridge embossments.

It is a feature according to some embodiments that the at least one feature (e.g., embossment enhancement feature) can comprise the angled alignment of the elongated embossments, in which a first array of the elongated embossments are projecting outwardly from a first side face of the filter media sheet and second array of the elongated embossments are projecting outwardly from a second side face of the filter media sheet opposite of the first side.

It is a feature according to some embodiments that the filter media pack utilizes only one of the at least one feature (e.g., embossment enhancement feature) (only one selected from the group of: (a) the saddles, (b) the offset alignment, (c) the bridge embossments, (d) angled alignment).

It is a feature that the inlet flow face can comprise a planar configuration, and the outlet flow face comprises a planar configuration, and preferably the inlet flow face is co-planar with the outlet flow face.

It is a feature that substantially all of the panels of the pleated filter media pack can have the elongated embossments formed therein.

It is a feature that the filter media pack can be incorporated into a filter cartridge, comprising a housing seal mounted to the pleated filter media pack and optionally a seal support for mounting of the housing seal.

### Additional Optional Features When Employing Saddles

It is a feature when using the saddles that the elongated embossments can comprise a variable embossment profile included alternating peaks and valleys following a sinusoidal path with a repeating period. A period the sinusoidal path can be offset as between adjacent elongated embossments such that the peaks of a first elongated embossment coincide laterally with the valleys of a second elongated embossment that is adjacent to the first elongated embossment.

In the above feature, the period can be offset by between ¼ and ¾, and more preferably by ½ of the period.

It is an alternative feature when using the saddles, the saddles can follow repeating period in a non-sinusoidal path.

In the above feature, peaks in the form of elongated ridges can be between adjacent saddles, with the elongated ridges having a longitudinal span that is at least 50% greater than a longitudinal span of the saddles, preferably between 50% and 300% of the longitudinal span of the saddles.

In the above feature, a period the non-sinusoidal path can offset as between adjacent elongated embossments such that the peaks of a first elongated embossment coincide laterally with the valleys of a second elongated embossment that is adjacent to the first elongated embossment.

It is a feature when using the saddles that the saddles provide valleys between adjacent peaks, wherein the elongated embossments can have a minimum depth at the valleys that is between 25% and 75% of a maximum depth at the peaks, and more preferably the minimum depth is between 35% and 65% of the maximum depth.

It is a feature when using the saddles, that the saddles provide valleys between adjacent peaks (and the elongated embossments may optionally vary in lateral width span) with a minimum lateral width span defined at the valleys and maximum lateral width span defined at the peaks, wherein the minimum lateral width span is between 50% and 100% of the maximum lateral width span, and if laterally varied the minimum lateral width span is more preferably between 60% and 85% of the maximum lateral width span.

It is a feature when using the saddles, that one saddle can be provided periodically every 2 to 8 centimeters.

### Additional Optional Features When Employing “Offset Alignment”

It is a feature when using the offset alignment that embossment location can be as follows in that the un-embossed/flat regions extend a lateral span between adjacent elongated embossments on each panel with the lateral midpoint therebetween thereby located at 50% of the lateral span, with the first set of elongated embossments engaging at a location that is between 0% and 30% of the lateral span, and more preferably between 5% and 20% of the lateral span.

In the above feature, lateral span of the un-embossed/flat regions can be at least 200% greater than a maximum width of the elongated embossments, with the lateral span of the un-embossed/flat regions preferably being between 200% and 600% of the maximum width of the elongated embossments.

### Additional Optional Features When Employing “Bridge Embossments”

It is a feature when using the bridge embossments that the bridge embossments can extend laterally greater than 50% of a lateral span between adjacent members of the elongated embossments, and preferably between 70% and 110% of the lateral span.

In the above feature, the bridge embossments preferably span entirely across the un-embossed/flat regions connecting adjacent members of the elongated embossments.

It is a feature when using the bridge embossments that at least 75% and preferably 90%-100% of the un-embossed/flat regions have bridge embossments between adjacent members of the elongated embossments on all of the panels having the elongated embossments.

It is a feature when using the bridge embossments that an arrangement can be provided wherein on each panel, the bridge embossments and the elongated embossments can project outwardly from opposite side faces of the filter media sheet, respectively.

It is a feature when using the bridge embossments that an arrangement can be provided wherein all of the elongated embossments face the same direction in the pleated filter media pack, the pleated filter media pack having successively alternating first and second panels, wherein: (a) the elongated embossments on first panels project outwardly from a first side face of the filter media sheet, and the elongated embossments on second panels project outwardly from a second side face of the filter media sheet opposite the first side face; and (b) the bridge embossments on first panels project outwardly from the second side face of the filter media sheet, and the bridge embossments on second panels project outwardly from a first side face of the filter media sheet opposite the second side face.

It is a feature when using the bridge embossments that the elongated embossments on a first panel can contact the bridge embossments of a second panel that is adjacent to the first panel.

It is a feature when using the bridge embossments that the bridge embossments can define a bridge width and a bridge depth, and wherein: (a) the bridge width can be between and 10% and 50% of a maximum width of the elongated embossments, and more preferably between 20% and 40% of the maximum width of the elongated embossments; and (b) the bridge depth can be between 10% and 50% of a maximum depth of the elongated embossments, and more preferably between 20% and 40% of the maximum depth of the elongated embossments.

It is a feature when using the bridge embossments that pair of formed gussets can integrally connect the bridge embossments with the elongated embossments.

It is a feature when using the bridge embossments that the bridge embossments can be elongated bridge embossments defining a bridge length/span between the adjacent members of the elongated embossments, and a bridge width perpendicular thereto, wherein the bridge width is between 1 and 3 millimeters, more preferably between 1 and 2 millimeters; and wherein the bridge length/span is between 4 and 36 millimeters, and more preferably between 8 and 20 millimeters, and wherein a maximum bridge embossment depth is between 0.2 and 1.0 millimeters, and more preferably between 0.3 and 0.8 millimeters.

It is a feature when using the bridge embossments that all of the panels that include elongated embossments can also include the bridge embossments.

### Additional Optional Features When Employing “Angled Alignment”

It is a feature when using the angled alignment of the elongated embossments that the elongated embossments can project an oblique angle relative to the pleat folds that is between 2 and 10 degrees, and more preferably between 3 and 8 degrees, most preferably about 5 degrees.

It is a feature when using the angled alignment of the elongated embossments that the elongated embossments can extend linearly.

It is a feature when using the angled alignment of the elongated embossments that the elongated embossments are formed into the filter media sheet in a common slanted direction, wherein in the folded arrangement, the elongated embossments on adjacent panels are angled in opposite slanted directions.

In the above feature, at least a set of the elongated embossments can be formed into the filter media sheet parallel with each other.

In the above feature, all of the elongated embossments can be formed into the filter media sheet parallel with each other.

It is a feature when using the angled alignment of the elongated embossments that a first array of the elongated embossments can be projecting outwardly from a first side face of the filter media sheet and second array of the elongated embossments can be projecting outwardly from a second side face of the filter media sheet opposite of the first side face, and wherein the embossments are angled in a common direction as formed into the filter media sheet such that with the pleat folds, the elongated embossments on adjacent panels are angled in opposite directions relative to each other.

It is a feature when using the angled alignment of the elongated embossments that wherein each of the elongated embossments can terminate short of the pleat folds, and linear score lines provide for the pleat folds.

In the above feature, each of the elongated embossments can be spaced from the pleat folds and thereby stop short of pleat folds.

### Additional Inventive Aspects and Features

Another inventive aspect is focused upon use of the saddle feature (may also be referred to as variable height embossments). According to this aspect, a filter media pack, comprises: a plurality of panels of a filter media extending transversely between an inlet flow face and an outlet flow face. The plurality of panels are arranged generally parallel, each having a first side face and a second side face opposite the first side face. By “generally parallel” it is meant parallel or within 2 degrees of parallel. A plurality of elongated embossments are formed into the panels and extend longitudinally between the inlet flow face and the outlet flow face. The elongated embossments are spaced laterally apart and separated laterally by intermediate regions (e.g., intermediate regions may be unembossed/flat regions), with each intermediate region between a respective pair of the elongated embossments. Furthermore, saddles are formed into the elongated embossments that are raised relative to the intermediate regions.

Any one or more of the optional saddle features and optional filter media pack features detailed earlier may be used in combination with this inventive aspect. Additional option features are detailed below.

While the configuration can be beneficial in non-pleated arrangements discussed herein, preferably the plurality of panels are connected in a single continuous sheet that is folded into a pleated configuration, wherein the filter media pack is a pleated filter media pack.

It is a feature that the elongated embossments can extend between 75% and 99% of a span of the panels between the inlet flow face and the outlet flow face, and more preferably between 95% and 99% of a span of the panels between the inlet flow face and the outlet flow face, and wherein the panels extend a span between the inlet flow face and the outlet flow face between 7 and 45 centimeters, more preferably between 10 and 35 centimeters.

It is a feature that the filter media sheet can comprise a blend of fibers comprising the cellulose fibers and the synthetic polymer fibers, wherein the blend of fibers comprises by weight percentage greater than 50% cellulose fibers; and more preferably between 70%-90% cellulose fibers and 10%-30% synthetic polymer fibers; and most preferably between 75%-85% cellulose fibers and 15%-25% synthetic polymer fibers.

It is a feature that the elongated embossments can comprise a maximum depth of between 1.0 and 4.5 millimeters, more preferably between 1.0 and 2.0 millimeters, and most preferably between 1.3 and 1.6 millimeters.

It is a feature that within an internal region of the filter media pack, the lateral span of the intermediate regions can be at least 200%, more preferably between 200% and 600%, and most preferably between 225% and 325% of the lateral span of each of the elongated embossments.

It is a feature that all of the elongated embossments can face the same direction in the filter media pack, in which the filter media pack has successively alternating first and second panels, wherein the elongated embossments on first panels project outwardly from a first side face of the filter media sheet, and the elongated embossments on second panels project outwardly from a second side face of the filter media sheet opposite the first side face.

It is a feature that the elongated embossments can comprise a variable embossment profile included alternating peaks and valleys following a sinusoidal path with a repeating period, and wherein a period the sinusoidal path is offset as between adjacent elongated embossments such that the peaks of a first elongated embossment coincide laterally with the valleys of a second elongated embossment that is adjacent to the first elongated embossment.

It is an alternative feature that the saddles follow repeating period in a non-sinusoidal path.

In the above feature peaks in the form of elongated ridges can be between adjacent saddles, with the elongated ridges having a longitudinal span that is at least 50% greater than a longitudinal span of the saddles, preferably between 50% and 300% of the span of the saddles.

It is a feature in the above feature that a period the non-sinusoidal path can be offset as between adjacent elongated embossments such that the peaks of a first elongated embossment coincide laterally with the valleys of a second elongated embossment that is adjacent to the first elongated embossment.

It is a feature that the saddles providing valleys between adjacent peaks, wherein the elongated embossments can have a minimum depth at the valleys that is between 25% and 75% of a maximum depth at the peaks, and more preferably the minimum depth is between 35% and 65% of the maximum depth.

It is a feature that the saddles provide valleys between adjacent peaks, and wherein the elongated embossments optionally vary in lateral width span with a minimum lateral width span defined at the valleys and maximum lateral width span defined at the peaks, with the minimum lateral width span that can be between 50% and 100% of the maximum lateral width span, and if laterally varied the minimum lateral width span can be more preferably between 60% and 85% of the maximum lateral width span.

It is a feature that one saddle can be provided periodically every 2 to 8 centimeters.

It is a feature that at least one additional feature (embossment enhancement) can be used in combination with the saddles, the at least one feature being any one or more of: (a) an offset alignment of embossments away from a midpoint of the intermediate regions; (b) bridge embossments formed into intermediate regions; or (c) angled alignment of the elongated embossments.

It is a feature that substantially all of the panels of the filter media pack have the elongated embossments formed therein.

Another inventive aspect is focused upon use of the “offset alignment” feature. According to this aspect, a filter media pack, comprises: a plurality of panels of a filter media extending transversely between an inlet flow face and an outlet flow face. The plurality of panels are arranged generally parallel, and each has a first side face and a second side face opposite the first side face. By “generally parallel” it is meant parallel or within 2 degrees of parallel. A plurality of elongated embossments are formed into the panels and extend longitudinally between the inlet flow face and the outlet flow face. The elongated embossments are spaced laterally apart and separated laterally by intermediate regions. Each intermediate region being between a respective pair of the elongated embossments. Further, an offset alignment of the elongated embossments is provided comprising a first set of the elongated embossments of first panels, and a second set of the elongated embossments of second panels that project in a common direction as the first set. The first set of the elongated embossments engage respective regions of the intermediate regions of the second panels at a location offset from a lateral midpoint defined between respective adjacent embossments of the respective regions of the intermediate regions of the second panels.

Any one or more of the optional “offset alignment” features and optional filter media pack features detailed earlier can be used in combination with this inventive aspect. Additional option features are detailed below.

While the configuration can be beneficial in non-pleated arrangements discussed herein, preferably the plurality of panels are connected in a single continuous sheet that is folded into a pleated configuration, wherein the filter media pack is a pleated filter media pack.

It is a feature that substantially all of the panels of the filter media pack have the elongated embossments formed therein.

It is a feature that the second set of the elongated embossments engage respective regions of the intermediate regions of the first panels at a location offset from a lateral midpoint defined between respective adjacent embossments of the respective regions of the intermediate regions of the first panels.

It is a feature that the intermediate regions extend a lateral span between adjacent elongated embossments on each panel with the lateral midpoint therebetween thereby located at 50% of the lateral span, wherein the first set of elongated embossments preferably engage at a location that is between 0% and 30% of the lateral span, and more preferably between 5% and 20% of the lateral span.

It is a feature that the lateral span of the un-intermediate regions can be at least 200% greater than a maximum width of the elongated embossments, with the lateral span of the intermediate regions preferably being between 200% and 600% of the maximum width of the elongated embossments.

It is a feature that at least one additional feature (embossment enhancement) can be used in combination with the offset alignment, the at least one feature being any one or more of: (a) saddles formed into the elongated embossments; (b) bridge embossments formed into intermediate regions; or (c) angled alignment of the elongated embossments.

It is a feature that the elongated embossments can extend between 75% and 99% of a span of the panels between the inlet flow face and the outlet flow face, and more preferably between 95% and 99% of a span of the panels between the inlet flow face and the outlet flow face, and wherein the panels can extend a span between the inlet flow face and the outlet flow face between 7 and 45 centimeters, more preferably between 10 and 35 centimeters.

It is a feature that the filter media sheet comprises a blend of fibers comprising the cellulose fibers and the synthetic polymer fibers, wherein the blend of fibers comprises by weight percentage greater than 50% cellulose fibers; and more preferably between 70%-90% cellulose fibers and 10%-30% synthetic polymer fibers; and most preferably between 75%-85% cellulose fibers and 15%-25% synthetic polymer fibers.

It is a feature that the elongated embossments can comprise a maximum depth of between 1.0 and 4.5 millimeters, more preferably between 1.0 and 2.0 millimeters, and most preferably between 1.3 and 1.6 millimeters.

It is a feature that within an internal region of the filter media pack, the lateral span of the intermediate regions can be at least 200%, more preferably between 200% and 600%, and most preferably between 225% and 325% of the lateral span of each of the elongated embossments.

It is a feature that all of the elongated embossments can face the same direction in the filter media pack. With the filter media pack having successively alternating first and second panels, the elongated embossments on first panels project outwardly from a first side face of the filter media sheet, and the elongated embossments on second panels project outwardly from a second side face of the filter media sheet opposite the first side face.

Another inventive aspect is focused upon use of the “bridge embossment” feature. According to this aspect, a filter media pack, comprises: a plurality of panels of a filter media extending transversely between an inlet flow face and an outlet flow face, with the plurality of panels arranged generally parallel and each having a first side face and a second side face opposite the first side face. By “generally parallel” it is meant parallel or within 2 degrees of parallel. A plurality of elongated embossments are formed into the panels and extend longitudinally between the inlet flow face and the outlet flow face, with the elongated embossments spaced laterally apart and separated laterally by intermediate regions, and with each intermediate region between a respective pair of the elongated embossments. Furthermore, bridge embossments are formed into the intermediate regions that extend laterally between adjacent members of the elongated embossments.

Any one or more of the optional “bridge embossment” features and optional filter media pack features detailed earlier can be used in combination with this inventive aspect. Additional option features are detailed below.

While the configuration can be beneficial in non-pleated arrangements discussed herein, preferably the plurality of panels are connected in a single continuous sheet that is folded into a pleated configuration, wherein the filter media pack is a pleated filter media pack.

It is a feature that substantially all of the panels of the filter media pack can have the elongated embossments formed therein.

It is a feature that the elongated embossments can extend between 75% and 99% of a span of the panels between the inlet flow face and the outlet flow face, and more preferably between 95% and 99% of a span of the panels between the inlet flow face and the outlet flow face, and the panels can extend a span between the inlet flow face and the outlet flow face between 7 and 45 centimeters, more preferably between 10 and 35 centimeters.

It is a feature that the filter media sheet can comprise a blend of fibers comprising the cellulose fibers and the synthetic polymer fibers, wherein the blend of fibers comprises by weight percentage greater than 50% cellulose fibers; and more preferably between 70%-90% cellulose fibers and 10%-30% synthetic polymer fibers; and most preferably between 75%-85% cellulose fibers and 15%-25% synthetic polymer fibers.

It is a feature that the elongated embossments can comprise a maximum depth of between 1.0 and 4.5 millimeters, more preferably between 1.0 and 2.0 millimeters, and most preferably between 1.3 and 1.6 millimeters.

It is a feature that within an internal region of the filter media pack, the lateral span of the intermediate regions can be at least 200%, more preferably between 200% and 600%, and most preferably between 225% and 325% of the lateral span of each of the elongated embossments.

It is a feature that all of the elongated embossments can face the same direction in the filter media pack. With the filter media pack having successively alternating first and second panels, the elongated embossments on first panels project outwardly from a first side face of the filter media sheet, and the elongated embossments on second panels project outwardly from a second side face of the filter media sheet opposite the first side face.

It is a feature that at least one feature (embossment enhancement feature) can be used in combination with the bridge embossments, which can be any one or more of: (a) saddles formed into the elongated embossments; (b) an offset alignment of embossments away from a midpoint of the intermediate regions; or (c) angled alignment of the elongated embossments.

It is a feature that the bridge embossments can extend laterally greater than 50% of a lateral span between adjacent members of the elongated embossments, and preferably between 70% and 110% of the lateral span, and most preferably the bridge embossments span entirely across the intermediate regions connecting adjacent members of the elongated embossments.

It is a feature that bridge embossments can be included in at least 75% and preferably 90%-100% of the intermediate regions between adjacent members of the elongated embossments, and most or all of the panels have the elongated embossments.

It is a feature that on each panel, the bridge embossments and the elongated embossments can project outwardly from opposite side faces of the filter media sheet, respectively.

It is a feature that all of the elongated embossments can face the same direction in the pleated filter media pack, with the filter media pack having successively alternating first and second panels, wherein: (a) the elongated embossments on first panels project outwardly from a first side face of the filter media sheet, and the elongated embossments on second panels project outwardly from a second side face of the filter media sheet opposite the first side face; and (b) the bridge embossments on first panels project outwardly from the second side face of the filter media sheet, and the bridge embossments on second panels project outwardly from a first side face of the filter media sheet opposite the second side face.

It is a feature that the elongated embossments on a first panel can contact the bridge embossments of a second panel that is adjacent to the first panel.

It is a feature that the bridge embossments can define a bridge width and a bridge depth, and wherein: (a) the bridge width is between and 10% and 50% of a maximum width of the elongated embossments, and more preferably between 20 and 40% of the maximum width of the elongated embossments; and the bridge depth is between 10% and 50% of a maximum depth of the elongated embossments, and more preferably between 20% and 40% of the maximum depth of the elongated embossments.

It is a feature that a pair of formed gussets integrally connect the bridge embossments with the elongated embossments.

It is a feature that the bridge embossments can be elongated bridge embossments defining a bridge length/span between the adjacent members of the elongated embossments, and a bridge width perpendicular thereto. The bridge width is between 1 and 3 millimeters, more preferably between 1 and 2 millimeters; and wherein the bridge length/span is between 4 and 36 millimeters, and more preferably between 8 and 20 millimeters, and wherein a maximum bridge embossment depth is between 0.2 and 1.0 millimeters, and more preferably between 0.3 and 0.8 millimeters.

It is a feature that all of the panels that include elongated embossments also include the bridge embossments.

Another inventive aspect is focused upon use of the “angled alignment” feature. According to this aspect, a filter media pack comprises: a plurality of panels of a filter media extending transversely between an inlet flow face and an outlet flow face, with the plurality of panels arranged generally parallel and each having a first side face and a second side face opposite the first side face. By “generally parallel” it is meant parallel or within 2 degrees of parallel. A plurality of elongated embossments are formed into the panels and extend longitudinally between the inlet flow face and the outlet flow face, with the elongated embossments spaced laterally apart and separated laterally by intermediate regions, each intermediate region between a respective pair of the elongated embossments. Furthermore, an angled alignment is provided to the elongated embossments, wherein the elongated embossments extend at an oblique angle relative to the pleat folds and provide intermittent contact locations with each other.

Any one or more of the optional “angled alignment” features and optional filter media pack features detailed earlier may be used in combination with this inventive aspect. Additional option features are detailed below.

While the configuration can be beneficial in non-pleated arrangements discussed herein, preferably the plurality of panels are connected in a single continuous sheet that is folded into a pleated configuration, wherein the filter media pack is a pleated filter media pack.

It is a feature that substantially all of the panels of the filter media pack can have the elongated embossments formed therein.

It is a feature that the elongated embossments can extend between 75% and 99% of a span of the panels between the inlet flow face and the outlet flow face, and more preferably between 95% and 99% of a span of the panels between the inlet flow face and the outlet flow face, and wherein the panels can extend a span between the inlet flow face and the outlet flow face between 7 and 45 centimeters, more preferably between 10 and 35 centimeters.

It is a feature that the filter media sheet can comprise a blend of fibers comprising the cellulose fibers and the synthetic polymer fibers, wherein the blend of fibers comprises by weight percentage greater than 50% cellulose fibers; and more preferably between 70%-90% cellulose fibers and 10%-30% synthetic polymer fibers; and most preferably between 75%-85% cellulose fibers and 15%-25% synthetic polymer fibers.

It is a feature that the elongated embossments can comprise a maximum depth of between 1.0 and 4.5 millimeters, more preferably between 1.0 and 2.0 millimeters, and most preferably between 1.3 and 1.6 millimeters.

It is a feature that within an internal region of the filter media pack, the lateral span of the intermediate regions can be at least 200%, more preferably between 200% and 600%, and most preferably between 225% and 325% of the lateral span of each of the elongated embossments.

It is a feature that at least one feature (embossment enhancement feature) can be used in combination with the angled alignment, the at least one feature being any one or more of: (a) saddles formed into the elongated embossments; (b) an offset alignment of embossments away from a midpoint of the intermediate regions; or (c) bridge embossments formed into intermediate regions.

It is a feature that the elongated embossments can project an oblique angle relative to the pleat folds that is between 2 and 10 degrees, and more preferably between 3 and 8 degrees, most preferably about 5 degrees.

It is a feature that the elongated embossments can extend linearly.

It is a feature that the elongated embossments are formed into the filter media sheet in a common slanted direction, wherein in a folded arrangement, the elongated embossments on adjacent panels are angled in opposite slanted directions.

It is a feature that the elongated embossment can be spaced from folds in the folded arrangement.

It is a feature that at least a set of the elongated embossments can be formed into the filter media sheet parallel with each other.

It is a feature that all of the elongated embossments can be formed into the filter media sheet parallel with each other.

It is a feature that a first array of the elongated embossments are projecting outwardly from a first side face of the filter media sheet and second array of the elongated embossments are projecting outwardly from a second side face of the filter media sheet opposite of the first side face, and wherein the embossments are angled in a common direction as formed into the filter media sheet such that when folded on top of each other, the elongated embossments on adjacent panels are angled in opposite directions relative to each other.

It is a feature that each of the elongated embossments terminates short of pleat folds which provide a pleated filter media pack, and wherein linear score lines provide for the pleat folds.

It is a feature that the each of the elongated embossments can be spaced from the pleat folds and thereby stop short of pleat folds.

Additional alternatively phrased aspects are described below, that may be used in combination with any of the features or aspects above either individual or in multiple aspects/features in combination.

An aspect is directed to a media pack for a filter element, including panels of media material supported in face-to-face relation with one another, each media panel including a plurality of embossments extending across the width of the media panel in parallel, evenly spaced-apart relation to one another, and opening in the same direction. At least some of the embossments vary in height from a surface of the media panel along the length of the embossment.

In this above aspect, the embossments may have a common width at the base of the embossment along the surface of the media panel, or all or some of the embossments may have different widths.

Also in this above aspect, the embossments can be arranged on the media panels such that the height of the embossments varies in a sinusoidal manner along the length of the embossment.

Also in the above aspect, adjacent embossments can also be arranged such that the peaks of one embossment are longitudinally offset from the peaks of an adjacent embossment, along the length of the embossments. In one aspect, the peaks of one embossment are longitudinally offset no more than 25% from the peaks of the adjacent embossment, along the length of the embossments.

Another aspect is directed toward a media pack for a filter element, including panels of media material supported in face-to-face relation with one another, each media panel including a plurality of embossments extending across the width of the media panel in parallel, evenly-spaced-apart relation to one another, and opening in the same direction, the media panels arranged relative to each other such that the embossments on one of the media panels are transversely offset from the embossments on an adjacent media panel no more than 25% the distance between adjacent embossments on the one panel.

Another aspect is directed toward a media pack for a filter element, including panels of media material supported in face-to-face relation with one another, each media panel including a plurality of embossments extending across the width of the media panel in parallel, evenly-spaced-apart relation to one another, and opening in the same direction, the media panels arranged relative to each other such that the embossments on one of the media panels are located between the embossments on an adjacent media panel. And further including support bridges on the media panel extending at least part of the transverse distance between at least some of the embossments on at least the one media panels. The support bridges can include plural support bridges on the media panel extending transversely between adjacent embossments on the media panels.

Another aspect is directed toward a media pack for a filter element, including panels of media material supported in face-to-face relation with one another, each media panel including a plurality of embossments extending across the width of the media panel in parallel, evenly-spaced-apart relation to one another, and opening in the same direction, with the embossments projecting at an angle to the opposite side edges of the media panel. The media panels are arranged relative to each other such that the embossments on one of the media panels are located in engaging contact with the embossments on an adjacent media panel.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric view of a pleated filter media pack with varied height embossments in accordance with a varied height embodiment of the present invention;

FIG. 2 is an expanded and isometric view a portion of an embossed and pleated sheet for making the filter media pack of FIG. 1;

FIG. 3 is an isometric view of a portion of a single embossed panel of sheet shown in FIG. 2 for better detail;

FIG. 4 is an end view of the filter media panel portion of FIG. 3;

FIG. 5 is a side view of the filter media panel portion of FIG. 3;

FIGS. 6, 6A and 6B are side, end and cross-sectional isometric views of a portion of a filter media pack of FIG. 1, respectively, but without the varied height embossments for purposes of comparison with the inventive embodiment;

FIGS. 7, 7A and 7B are side, end and cross-sectional isometric views of a portion of a filter media pack of FIG. 1, respectively, further illustrating the varied height embossments for purposes of comparison with FIGS. 6, 6A and 6B;

FIG. 8 is a top surface end profile view through a saddle portion of a “squished” option for the varied height embossment for the varied height embossment embodiment of FIG. 1;

FIG. 9 is a top surface end profile view through a saddle portion of a “chopped” option for the varied height embossment for the varied height embossment embodiment of FIG. 1.

FIG. 10 is a top surface end profile view through a saddle portion of a “translated” option for the varied height embossment for the varied height embossment embodiment of FIG. 1;

FIG. 11 is a plan view of a portion of the filter media sheet using the translated option of FIG. 10;

FIG. 12 is a side profile view of adjacent embossments along a panel of the filter media pack of FIG. 1 showing a sinusoidal path of the embossments with a repeating period and a ½ offset of the period as between adjacent embossments (e.g., in parallel spaced relation);

FIG. 13 is side profile view of adjacent embossments along a panel of the filter media pack similar to that for FIG. 12, but according to an alternative option also with embossments that follow a sinusoidal path and a repeating period, but with an offset of the period that is less than ½ of the period as between adjacent embossments (e.g., in parallel spaced relation);

FIG. 14 is side profile view of adjacent embossments along a panel of the filter media pack similar to that for FIG. 12, but according to an alternative option of a longer length period than that of FIG. 12, and also with a sinusoidal path of the embossments with a repeating period and a ½ offset of the period as between adjacent embossments (e.g., in parallel spaced relation);

FIG. 15 is side profile view of adjacent embossments along a panel of the filter media pack similar to that for FIG. 12, however according to an alternative option with embossments that follow a non-sinusoidal path the periodic saddles spaced along a repeating period, and in which the periods of adjacent embossments may or may not be offset (with no offset shown in that of FIG. 15 as the saddles of adjacent embossments align from the side view);

FIG. 16 is cross-sectional view taken through a filter media pack transversely through embossments illustrating an offset embossment alignment of less than half of the spacing between embossments of adjacent panels, according to an offset alignment embodiment of the present invention, (and with dashed lines contemplating idealized potential deflection of the flat regions of the filter media sheet in the folded pack and subject to squeeze pressure);

FIG. 17 is cross-sectional view the same as that of FIG. 16 but with an offset embossment alignment at half of the spacing between embossments of adjacent panels for purposes of comparison of the inventive embodiment of FIG. 16 (and with dashed lines contemplating idealized potential deflection of the flat regions of the filter media sheet in the folded pack and subject to squeeze pressure);

FIG. 18 is an expanded and isometric view a portion of an embossed and pleated sheet for making the filter media pack of for the offset alignment embodiment of FIG. 16;

FIG. 19 is an assembled isometric view of a filter media pack using the embossed and pleated sheet of FIG. 18 and through which a cross-section may be taken for that of FIG. 16;

FIG. 20 is an isometric view of a portion of a filter media sheet with bridge embossments arranged between longitudinal embossments, according to a bridge embossment embodiment of the present invention;

FIG. 21 is a cross-sectional view taken through a filter media pack transversely through the longitudinal embossments (and with dashed lines contemplating idealized potential deflection of the flat regions of the filter media sheet in the folded pack and subject to squeeze pressure);

FIG. 22 is cross-sectional view of the filter media pack taken perpendicularly to that of FIG. 21 to show a side view of the bridge embossment features;

FIG. 23 is an expanded and isometric view a portion of an embossed and pleated sheet with bridge embossment features of that of FIGS. 20-22 for making the filter media pack according to the bridge embossment embodiment;

FIG. 23A is an enlarged view of a circle portion of FIG. 23;

FIG. 24 is an isometric view of a pleated filter media pack with the laterally extending bridge embossments made with the filter media sheet of FIG. 23;

FIG. 25 is a plan view of a portion of a filter media sheet with angled embossments according to an angled embossment embodiment of the present invention, with two edges of the depicted portion parallel to the pleat tips and two edges perpendicular to pleat tips in order to show an angle of the elongated embossments relative to pleat tips;

FIG. 26 is an isometric view of the filter media sheet portion of FIG. 25;

FIG. 27 is an end view of the filter media sheet portion of FIG. 25;

FIG. 28 is a cross sectional view of a filter media pack constructed with angled embossments according to the angled embossment embodiment of FIG. 25 (a flow inlet view with cross section taken parallel to inlet face);

FIG. 29 is another cross sectional view similar to that of FIG. 28, of the filter media pack of the angled embossment embodiment, but with the cross section taken along an inclined plane relative to the inlet face for an isometric view of the angle embossment features;

FIG. 30 is a filter media pack assembled using a filter media sheet with angled embossments according to the angled embossment embodiment of FIG. 25;

FIG. 31 is an expanded and isometric view a portion of an embossed and pleated sheet for making the filter media pack of FIG. 30;

FIG. 32 is close-up isometric view of a pleat tip used at the inlet and outlet faces of that is used in FIG. 30 that employs a single score line (it being understood that the pleat tips at the inlet and outlet faces may be configured the same; and that this pleat score and fold configuration also usable for other similar FIGS. 2, 18 23, 36 and 38 embodiments);

FIG. 33 is an enlarged isometric view of a pleat tip region of the filter media sheet portion shown used for another embodiment of the type with offset alignment of that FIG. 18, which in this case uses two score lines (and also usable for other similar FIGS. 2, 23, 31, 36 and 38 embodiments);

FIG. 34 is an enlarged isometric view of the pleat tip region of the filter media sheet using two score lines as in FIG. 33 (it being understood that the pleat tip regions with pleat creases at both of the inlet and outlet faces may be configured the same).

FIG. 35 is a filter media pack assembled using a filter media sheet with variable height and offset embossments according to a combination feature embodiment, in accordance with yet a further embodiment of the present invention;

FIG. 36 is an expanded and isometric view a portion of an embossed and pleated sheet for making the filter media pack of FIG. 35;

FIG. 37 is a filter media pack assembled using a filter media sheet with variable height and offset embossments and further including bridge embossments according to another combination feature embodiment, in accordance with yet a further embodiment of the present invention;

FIG. 38 is an expanded and isometric view a portion of an embossed and pleated sheet for making the filter media pack of FIG. 37;

FIG. 39 is a side profile and cross-section view through a filter media sheet with offset alignment embossments for that used in FIG. 18 (but shown in flat form rather than partially folded) which in this case uses a single score line for the pleat fold (and such pleat score/folding feature also usable for other similar FIGS. 2, 23, 31, 36 and 38); and

FIG. 40 is a close up isometric view of portion of the filter media sheet in FIG. 39, with the pleat fold as it is being folded by the single score line, that once folded appears as in in FIG. 32.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

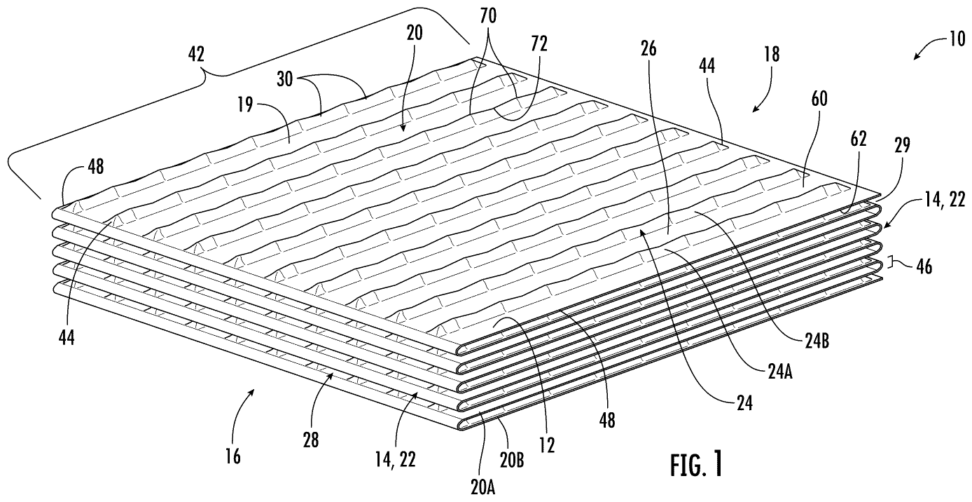

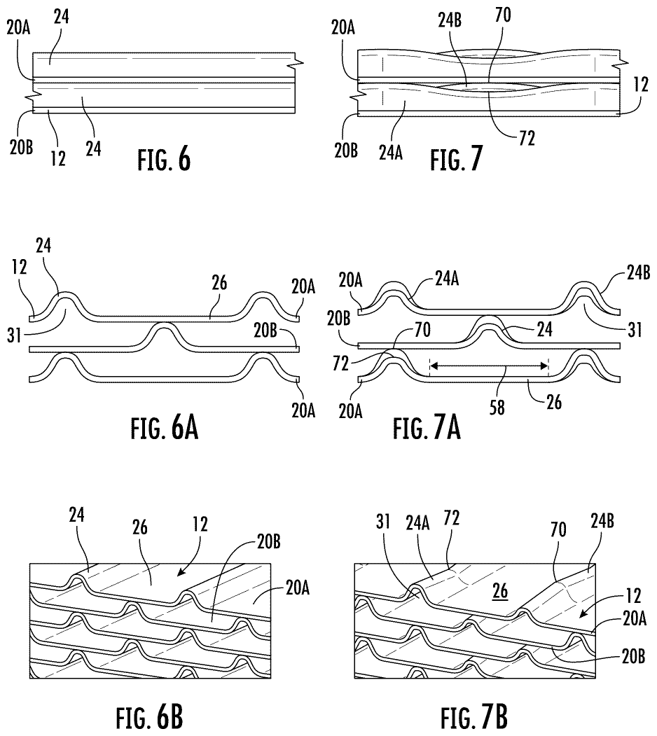

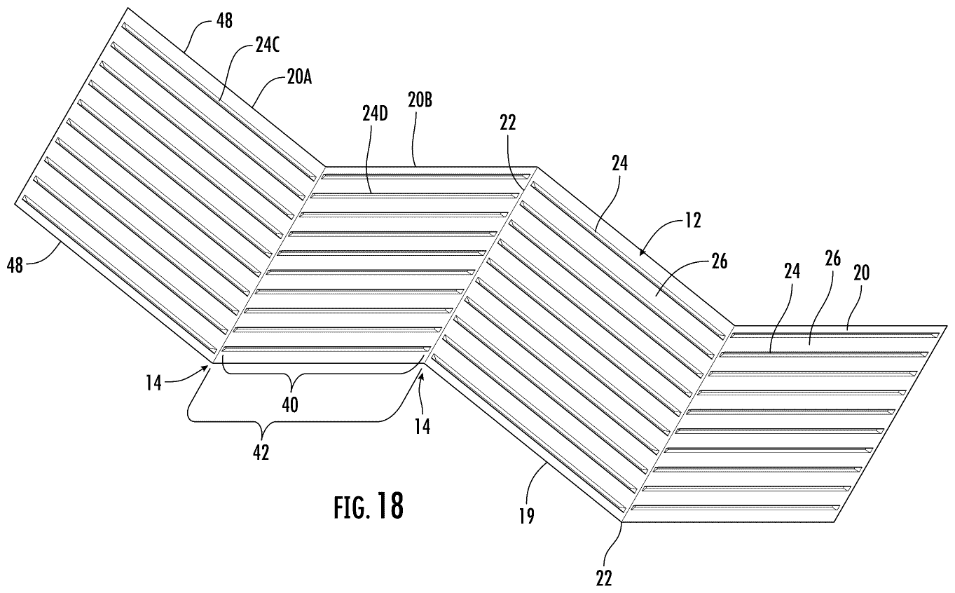

Before turning to individual illustrated embodiments, a global overview roadmap of the different embodiments will be provided. Different illustrated embodiments of the present invention have been depicted in different filter media packs 10, 110, 210, 310, 410, 510 in FIGS. 1-38, each of which can be directed toward reducing blinding, providing structural integrity, or otherwise improving air flow. For better detail, these packs 10, 110, 210, 310, 410, 510 have been shown with a relatively limited number of pleats, but it is understood that often many more pleats can be used in larger/wider filter media pack. The actual number of pleats and pack size depends upon the particular filtration application.

Each of the illustrated embodiments share common features, such that the same reference numbers will be used for common features among different embodiments. For example, each of the filter media filter media packs 10, 110, 210, 310, 410, 510 include a filter media sheet 12 folded along pleat folds 14 at an inlet flow face 16 and pleat folds 14 at an outlet flow face 18. The folds 14 provide a plurality of pleats 19 with panels 20 (panels 20 may also be referenced as “pleat panels”) extending between the inlet flow face 16 and the outlet flow face 18.

It can be seen and understood that the inlet flow face 16 and the outlet flow face 18 may be configured generally the same as a collection of pleat tips 22 provided by pleat folds 14 at one end or the other, and therefore may be interchangeable (e.g., such that the inlet face 16 may be used at the outlet face 18 and the outlet face 18 used as the inlet face 16 in use). Thus, another way to phrase is that inlet and outlet flow faces are opposite flow faces in which in use one face is selected to become the inlet flow face and the other the outlet flow face in use.

Often, the collections of pleat tips 22 are aligned planar to for planar inlet and outlet flow faces 16, 18 for the respective filter media packs 10, 110, 210, 310, 410, 510 as shown. However, either or both of the inlet and outlet flow faces 16, 18 may be inclined or curved (for example, if pleat panels 20 are not of equal sizes or the filter media pack is bent into form when installed into a frame or sealing system).

Each of the illustrated embodiments also commonly comprise a plurality of elongated embossments 24 formed into the filter media sheet 12. The elongated embossments 24 extend longitudinally between the inlet flow face 16 and the outlet flow face 18. The elongated embossments 24 are also spaced laterally apart and separated laterally by un-embossed/flat regions 26 (which may also be more generically referred to as “intermediate region”).

The un-embossed/flat regions 26 correspond to regions of the filter media sheet 12 that are flat and/or are not embossed by the formed elongated embossments 24 into the filter media sheet 12 (i.e., the regions between adjacent elongated embossments 24). Typically, the filter media sheet 12 will be fed for embossing from a storage roll to a roll or die press, and by un-embossed/flat regions 26, it is referring to those portions that are not formed in the regions between the elongated embossments 24 during embossing.

With this arrangement, inlet flow channels 28 are created along the un-embossed/flat regions between elongated embossments 24 and/or within the trough passageways 31 defined within the elongated embossments 24, along one side of the filter media sheet; and outlet flow channels 29 are created along the un-embossed/flat regions between elongated embossments 24 and/or within the trough passageways 31 defined within the elongated embossments 24, along the opposite side of the filter media sheet 12.

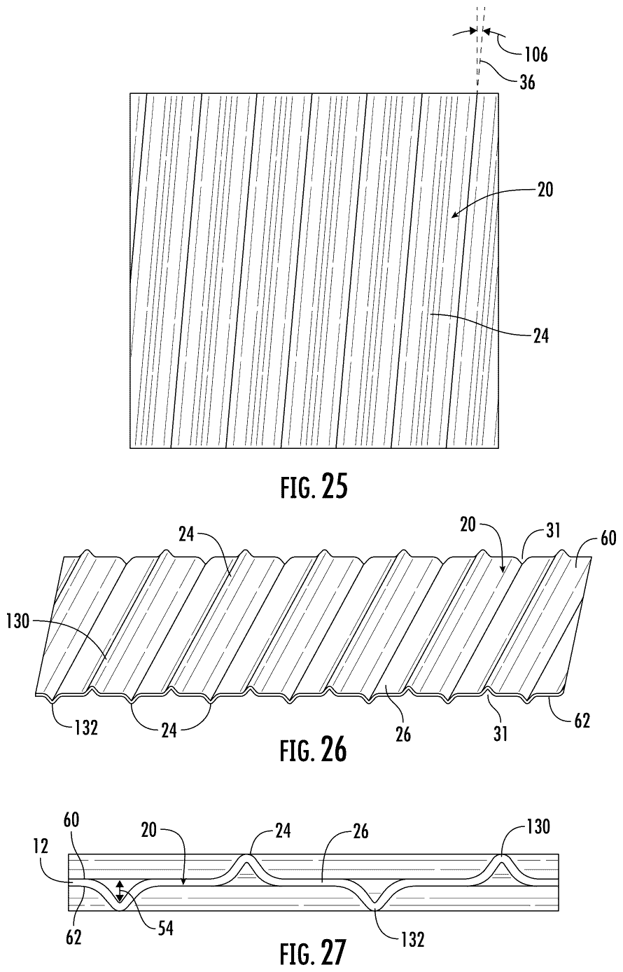

With this arrangement of inlet and outlet flow channels, 28, 29, unfiltered air flow can enter through the inlet flow face 16, entering through inlet flow channels 28 axially. By axially, it is meant perpendicularly relative to the inlet flow face 16, or otherwise primarily in the axial direction (as such this term “axially” is broad enough to encompass angled alignment of embossments in FIGS. 25-31). By flowing axially into the inlet flow face 16, the air flow enters into the filter media pack interior. The unfiltered air flow passes laterally through the filter media sheet via pores of the filter media sheet 12. Such pores are created by a matrix of filter media fibers therein, in which the filter media sheet 12 traps undesirable particulates and contaminants upon the upstream side and within the matrix of filter media fibers therein, thereby filtering the air flow. As a result, the air flow exits the filter media sheet 12 into the outlet flow channels 29 in a filtered state creating a filtered air flow in the outlet flow channels 29 that pass axially toward the outlet flow face 18 and exits the outlet flow face 18 in a cleaner state than the air entering the inlet flow face 16.

In addition to the elongated embossments 24, each of the filter media packs 10, 110, 210, 310, 410, 510 further at least one feature (may also be referred to as an embossment enhancement) that comprises any one or more of the following: (a) saddles 30 formed into the elongated embossments 26 that are raised relative to the un-embossed/flat regions 26; or (b) an offset alignment 32 of the elongated embossments that avoids nesting and is offset from midpoint of un-embossed/flat regions 26; or (c) bridge embossments 34 formed into the un-embossed/flat regions 26 that extend laterally between adjacent members of the elongated embossments 24; or (d) an angled alignment 36 of the elongated embossments 24, wherein the elongated embossments 34 extend at an oblique angle relative to the pleat folds 14 (e.g., pleat tips 24).

Any one or more of features (e.g., saddles 30, offset alignment 32, bridge embossments 34, or angled alignment 36) enhance the function of the elongated embossments 26 by providing any one or more of the following functions: (a) bridge/beam strength laterally between the elongated embossments, (b) panel/embossment rigidity, (c) intermittent contact points, or (d) stiffness/anti-relaxation of pressed features in the filter media sheet.

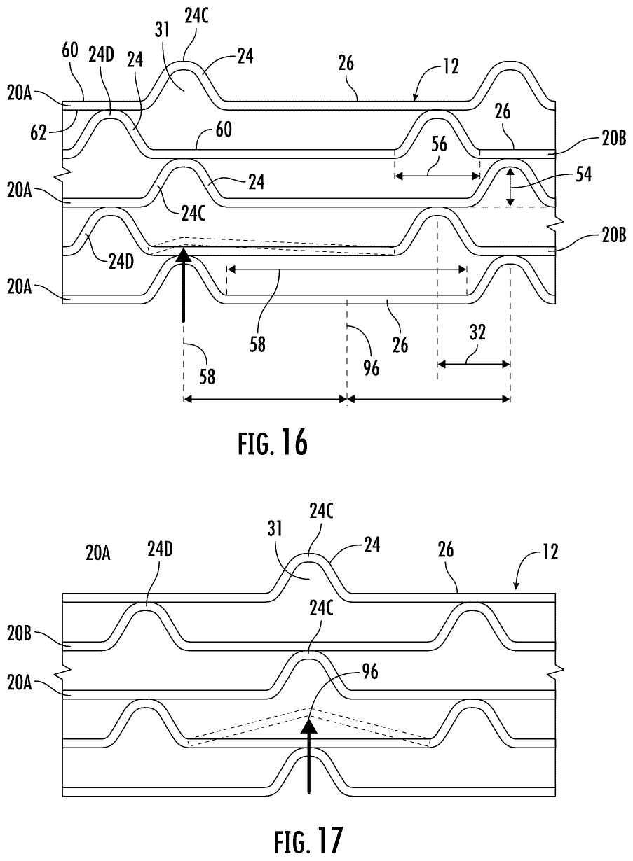

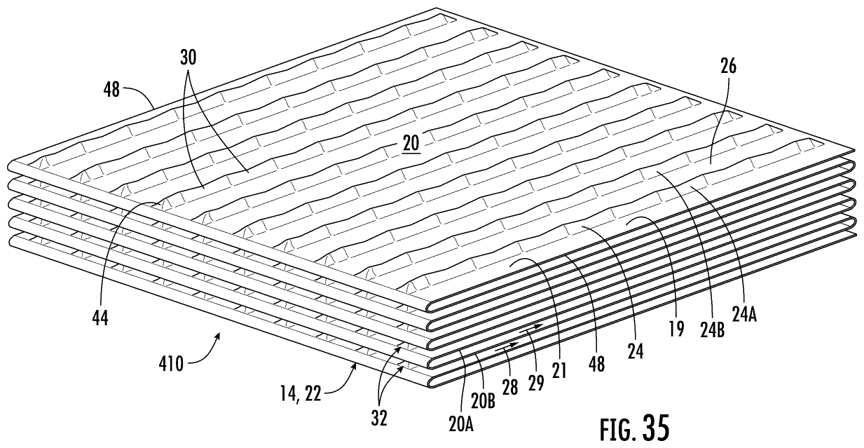

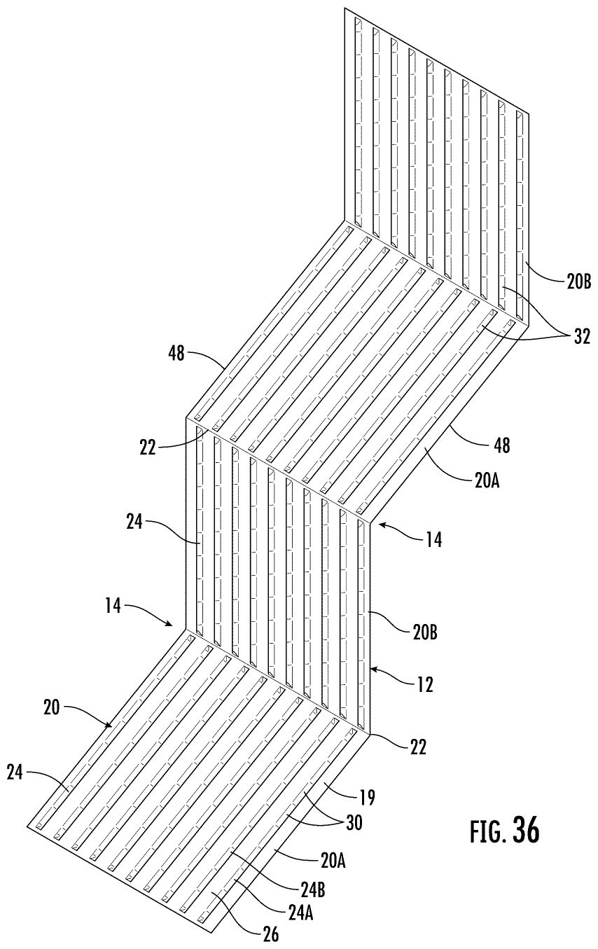

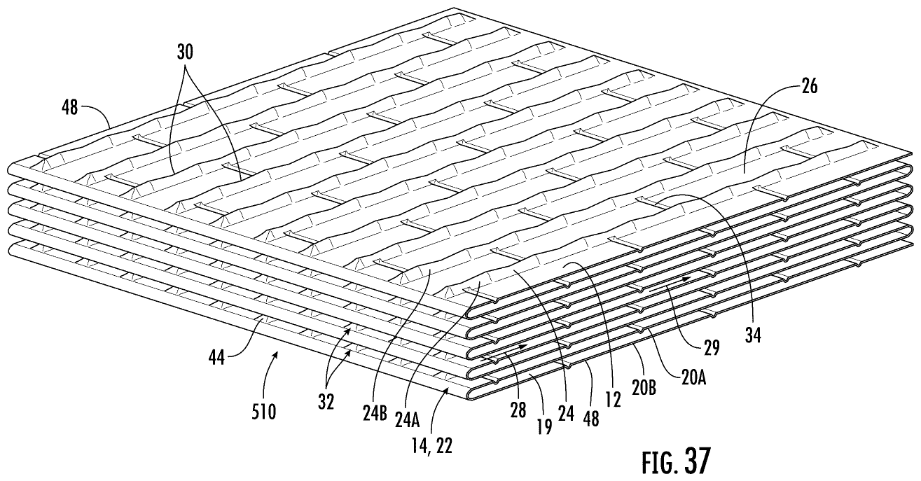

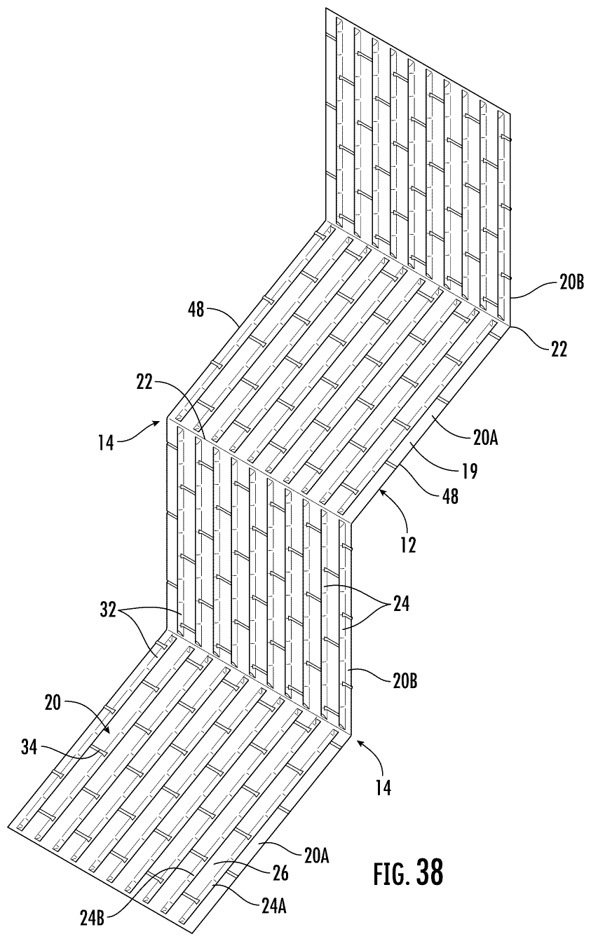

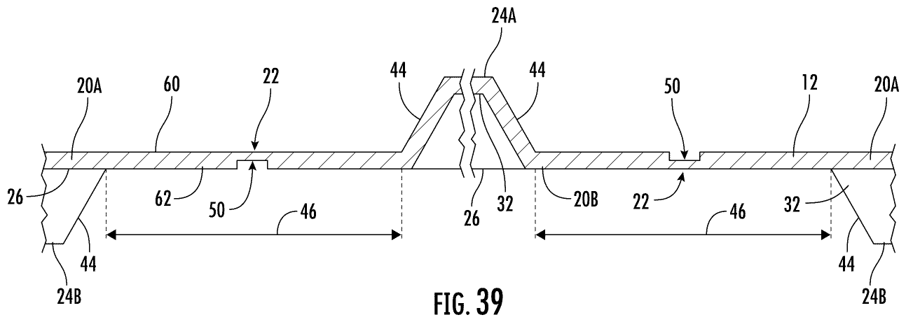

At this point in the discussion, it can be seen that some embodiments may include only one of these features. For example, only saddles 30 are in FIGS. 1-5, 7-15; only offset alignment 32 are in FIGS. 16, 18-19; only bridge embossments 34 are in FIGS. 20-24; and only angled alignment 36 are shown in FIGS. 25-33. Additionally, some embodiments may include two or more of these features and sometimes all of these features. For example, FIGS. 35-36 demonstrate a filter media pack 410 with the at least one feature including the following two features: saddles 30 and offset alignment 32. As another illustrated example, FIGS. 37-38 demonstrate a filter media pack 510 with the at least one feature including the following three features: saddles 30, offset alignment 32, and bridge embossments 34.

From the foregoing, it should also be apparent as used throughout this application “or” is understood to mean “inclusive or”, especially in relation to the presence of at least one feature. Unless expressly stated to the contrary for a recitation (e.g., either a or b, but not both would be a contrary indication) or otherwise evident from context, “or” refers to an “inclusive or” and not to an “exclusive or”. For example, a feature/condition A, B or C is satisfied by any of the following: A is true (or present) and B and C are false (or not present); B is true (or present) and A and C are false (or not present); C is true (or present) and A and B are false (or not present), any combination of two from the group of A, B and C are true (or present) and the remaining feature/condition is false (or not present), or the combination of each of A, B, and C are true (or present) without any false(or not present) feature/condition.

For example, use of “or” in reference to the at least one feature comprising: (a) saddles 30, or (b) offset alignment 32, or (c) bridge embossments 34, or angled (d) alignment 36 is broad enough to encompass any and all of the fifteen unique different embodiments A-O presented in Table 1 below (including the five illustrated embodiments and ten other embodiments not illustrated), in which each line item indicates the presence or absence of each respective feature for that embodiment. Furthermore, as should be readily apparent the use of comprising allows yet for optional additional features to also be included that could further enhance anti-blinding or flow characteristic benefits, so long as at least one of the enumerated features is included.

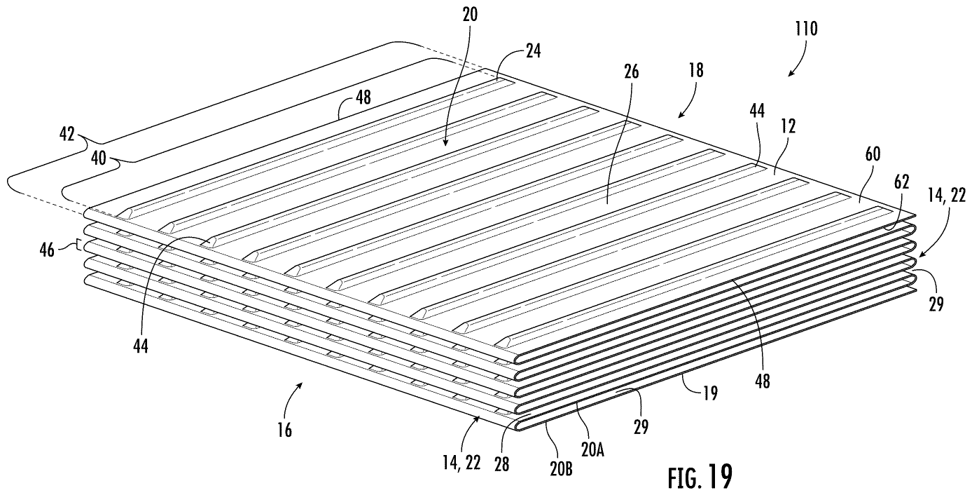

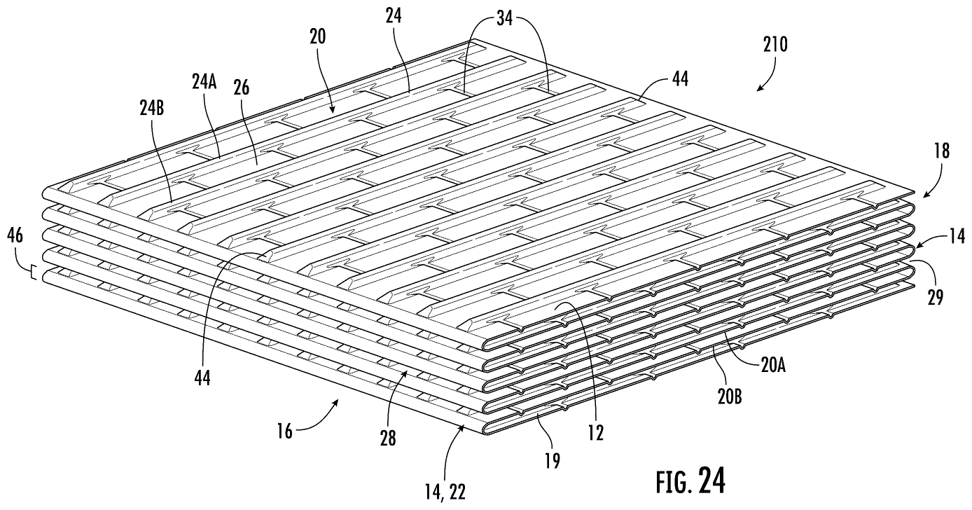

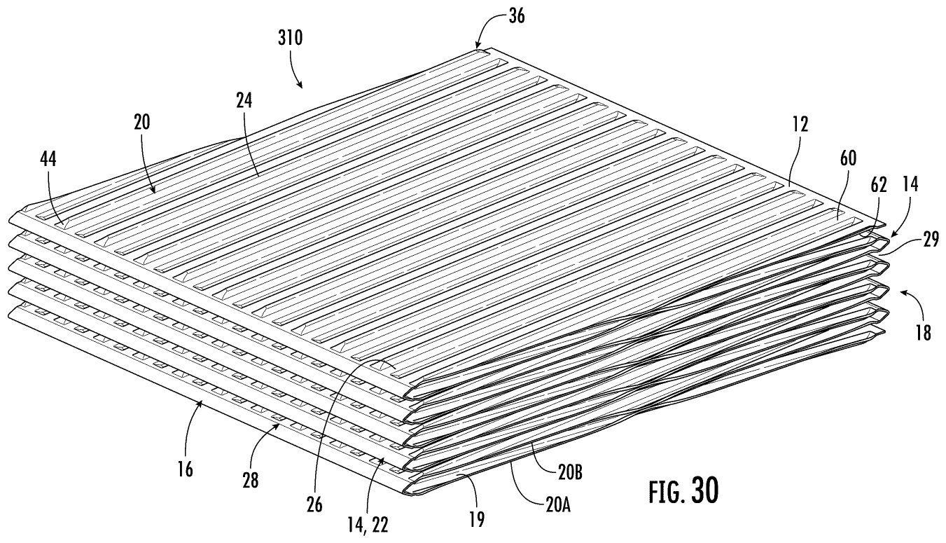

TABLE 1
Different Feature Combinations of Embodiments

| | Presence of features in each Embodiment: | | | |
|---|---|---|---|---|
| | | Offset | Bridge | Angled |
| | Saddles | Alignment | Embossments | Alignment |
| Embodiments | 30 | 32 | 34 | 36 |
| A (e.g., FIG. 1) | YES | NO | NO | NO |
| B | YES | YES | NO | NO |
| C (e.g., FIG. 37) | YES | YES | YES | NO |
| D (e.g., FIG. 35) | YES | YES | NO | YES |
| E | YES | YES | YES | YES |
| F | YES | NO | YES | NO |
| G | YES | NO | NO | YES |
| H | YES | NO | YES | YES |
| I (e.g., FIG. 19) | NO | YES | NO | NO |
| J | NO | YES | YES | NO |
| K | NO | YES | NO | YES |
| L | NO | YES | YES | YES |
| M (e.g., FIG. 24) | NO | NO | YES | NO |
| N | NO | NO | YES | YES |
| O (e.g., FIG. 30) | NO | NO | NO | YES |

Before turning to further details of the structural enhancements/anti-blinding features, additional attention will be continued for other common features that may be used among the embodiments as illustrated in the various filter media packs 10, 110, 210, 310, 410, 510 in FIGS. 1-38.

To maintain pleat separation and for orderly flow, the elongated embossments 24 preferably extend a longitudinal span 40 between 75% and 99% of a span 42 of the panels 20 between the inlet flow face and the outlet flow face (e.g., the distance between the pleat tips 22 at opposed inlet/outlet faces 16, 18). More preferably, the embossment longitudinal span 40 is between 95% and 99% of a span 44 of the panels between the inlet and outlet flow faces 16, 18.

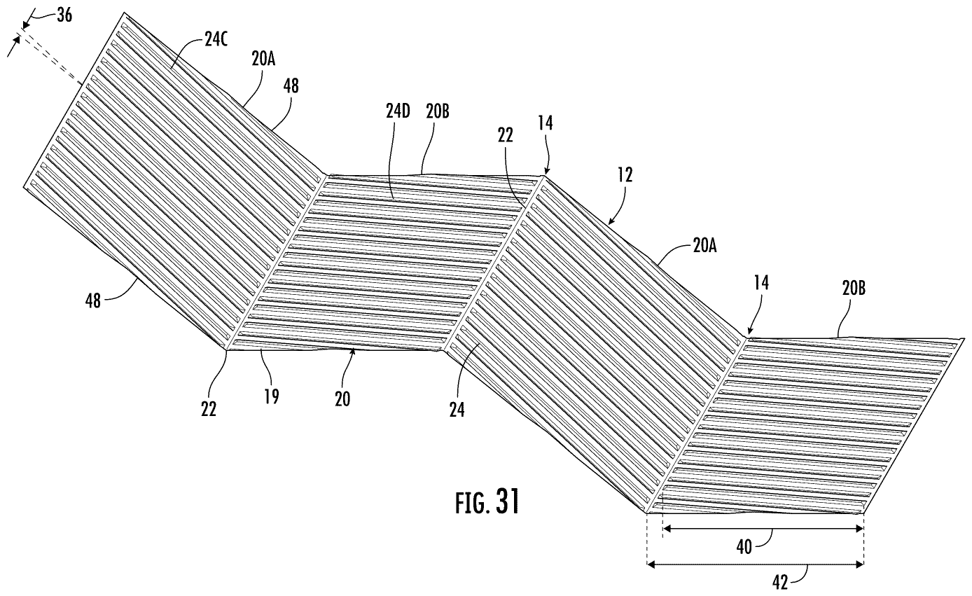

In the first three embodiments, the embossment longitudinal span 40 equals the actual length of embossments (such span and measurement including tapered end portions 44) as the elongated embossments 24 extend perpendicularly relative to the pleat folds 14. However, if the embossments are angled as in the angled alignment 36, the embossment span 40 is measured perpendicular to the pleat tips 22 for purposes of comparison with the pleat panel span 42 as shown in FIG. 31. Accordingly, as used herein, the embossment longitudinal span 40 refers to percent of coverage that the embossments cover between the pleat tips 22 (for example, the distance between the planes created by the inlet and outlet flow faces 16, assuming a more typical rectangular cuboid design as shown).

While the embossments could extend through pleat tips 22 and be continuous through the pleat folds in some embodiments of the present invention, this is not preferred; and as shown, the embossments stop short of the pleat tips 22. This way, the configuration and arrangement of the elongated embossments 24 can be maximized while not interfering with pleating and inlet/outlet flow face formation.

Furthermore, as shown, the elongated embossments 24 may have tapered end portions 44 proximate to the inlet and outlet faces 16, 18 that provide widened mouth entrance and exit regions for air flow to enhance air flow characteristics. The tapered end portions 44 may facilitate easier folding and may prevent tears in the media sheet near pleat folds.

Between the tapered end portions 44, the elongated embossments 24 can have a constant maximum depth 54 (i.e., a constant depth other than the depth being interrupted by saddles 30 if used), which in conjunction with pleat folds provides a parallel relationship between pleat panels 20 when compacted in the filter media pack 10, 110, 210, 310, 410, 510. Some variation from parallel could be contemplated and hence “generally parallel” is sometimes used in the description, in that that the pleat panels 20 extend generally parallel with each other (e.g., if the embossment depth was slightly shallower near one flow face as compared to the other). As such, as used herein by “generally parallel” it is meant to mean and include both parallel and within 2 degrees of parallel.

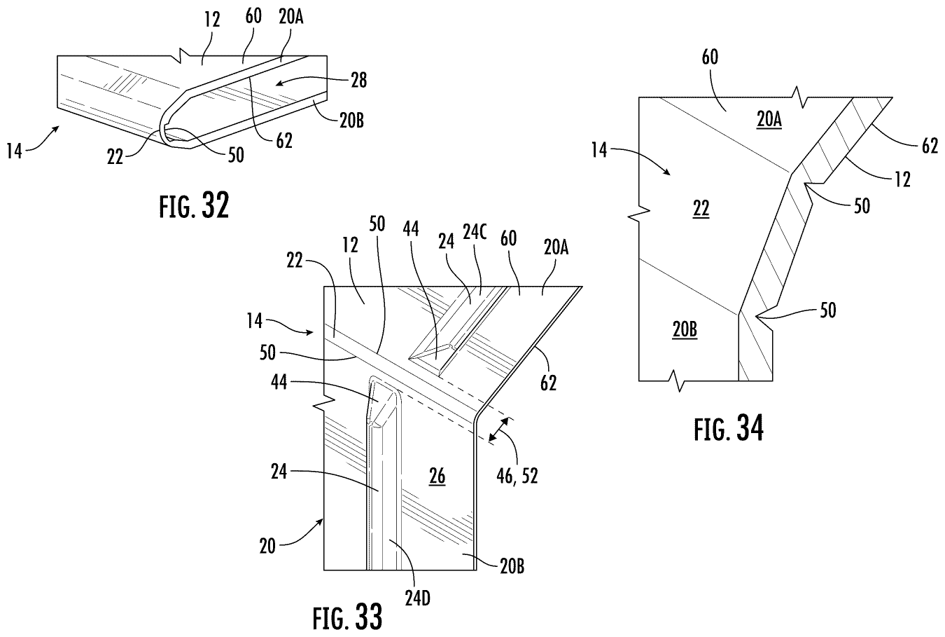

Another common feature that may be employed as shown is creasing regions 46 are provided that are free of the elongated embossments 24 to facilitate easier folding of the pleats 19. Creasing regions 46 free of embossments are provided that extend transversely between opposed side edges 48 of the filter media sheet 12 (see e.g., an enlarged view of FIGS. 33 and 34). The creasing regions 46 have a width parallel to the opposed edges spanning a creasing region span 52 between 0.1 and 3.0 centimeter, more preferably between 0.2 and 1.0 centimeter (shown in FIG. 33, and this span 52 can be measured easiest and best with the filter media sheet in an unfolded state such as laying on a flat surface).

To provide for the pleat folds, the filter media sheet may be simply folded in the location of the creasing region 46 without score lines at regular spaced intervals to provide any of the filter media packs 10, 110, 210, 310, 410, 510. The creasing region 46 does not have the bridge strength like the remainer of the panels with embossments that provide bridge strength. However, there can be advantages to using score lines that can predetermine fold locations, making folding easier and providing better fold consistency.

Accordingly, at least one score line 50 can be formed in each creasing region 46 thereby to facilitate the pleat folds 14. For example, there may be one or two score lines 50 in comparing FIG. 32, 39-40 with FIGS. 33-34. Either one or two score lines 50 for each fold 14/pleat tip 22 may be used in any of the filter media packs 10, 110, 210, 310, 410, 510.

As far as the “creasing region” is concerned, and best shown in FIG. 33 (for two score lines for each fold) and FIG. 39 (for a single score line for each fold), the elongated embossments 24 reside outside of the creasing regions 46. The elongated embossments 24 taper toward and end at the creasing regions 46 at opposite ends of the elongated embossments 24 (e.g., see also FIGS. 1, 2, 18, 19, 23, 24, 30, 31 showing the embossments not extending into the pleat folds 14 of creasing regions 46).

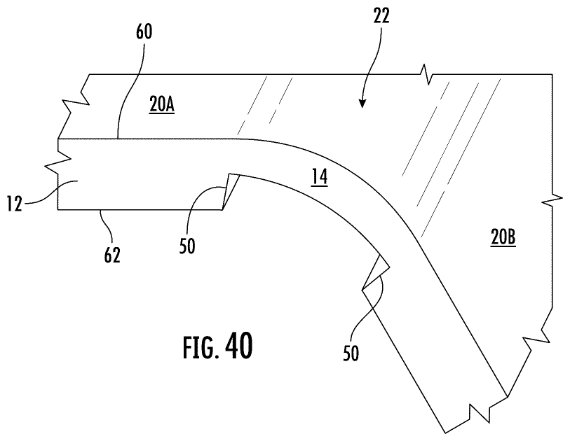

As noted above, score lines 50 can be used to predetermine and better provide for the pleat folds 14 and pleat tips 22. For example, either one score line 50 may be formed in the creasing region 46 in some embodiments (as in FIGS. 39-40), or two score lines 50 are formed into the creasing regions 46 (FIGS. 32-34). Such score lines 50 are arranged in spaced apart relationship (e.g., parallel).

As shown in FIG. 34 each fold may have two parallel score lines to predetermine fold locations and help configure the width of the pleat tips 22. This may result in a flatter pleat tip profile that may be considered flat.

Alternatively, when using a single score line 50, it may be positioned at or near an apex of the intended pleat tip 22 and provide for a single specific target area of weakness/pre-crease in which can more easily be folded over as shown in FIG. 40. This may also result in a more rounded pleat tip 22 profile once fully folded as shown in FIG. 32.

For example, such single or double score lines 50, may optionally be formed at the same time as the embossments 20, and formed with a shallow depth at between 10-60% of the filter media sheet 12 caliper thickness, and a width that may be between 0.5 and 1 millimeter.

While some embodiments might contemplate interrupted or intermittent embossments as the elongated embossments 24, preferably all of the elongated embossments 24 are uninterrupted and extend continuously an entire span between the creasing regions 46, such as shown in the filter media packs 10, 110, 210, 310, 410 of FIGS. 1-38. It is an advantage that the bridge strength and spacing is better maintained with continuity of elongated embossments 24, and that flat regions that provide weakness or pivot regions are avoided in the filter media sheet. In regard to the feature of saddles 30 that are used in some embodiments, the saddles 30 avoid interruption and maintain continuous extension of the elongated embossments, because the elongated embossment even at the saddle, is formed and elevated relative to the unembossed/flat region 26 of the filter media sheet 12.

The embodiments are particular advantageous for deeper filter media packs that are more subject to issues with blinding whereby elongated embossments 24 and other features can maintain more orderly flow. For example, the pleat panels 20 can extend a span 42 between the inlet flow face 16 and the outlet flow face 18 between 7 and 45 centimeters, and more preferably between 10 and 35 centimeters.

The filter media sheet 12 can comprise a filter media containing fibers. For example, the filter media sheet 12 can comprise any one or more of the following: cellulose fibers, synthetic polymer fibers, or glass fibers.

For example, frequently, the filter media sheet 12 comprises a blend of fibers comprising the cellulose fibers and the synthetic polymer fibers.

Some further discussion of cellulose/synthetic filter medias is warranted at this point. Filter medias that are primarily cellulose based are less prone to be set and fixed (i.e., more prone to relax) as compared with primarily thermoplastic polymer medias that can better be heat set and retain embossment and pleat panel shape. Additionally, many typical thermoplastic polymer filter media fibers have the ability to stretch more than cellulose filter media fibers. Thermoplastic polymer filter media fibers may therefore afford greater embossment depth. However, cellulose fibers can offer other benefits and are desirable for many filtration applications.

Accordingly, while the elongated embossments 24 in combination with at least one additional structural feature (e.g., saddles 30, or offset alignment 32, or bridge embossments 34, or angled alignment 36) would enhance primarily thermoplastic polymer medias, these features are particularly useful and advantageous with primarily cellulose filter medias. For example, in the filter media sheet 12, the blend of cellulose fibers and polymer fibers comprises by weight percentage greater than 50% cellulose fibers; and more preferably between 70-90% cellulose fibers and 10-30% synthetic polymer fibers; and most preferably between 75-85% cellulose fibers and 15-25% synthetic polymer fibers (which may sometimes be referred to as 80/20 cellulose media).

In many designs with primarily thermoplastic polymer medias, it is possible to use alternating flat pleat panels and embossed panels more easily, such as shown in some embodiments of US2022/0096985A1 to Tate et al. This is due to the strength of heat set of thermoplastic fibers. Because primarily cellulose fiber medias have less ability to stretch and prone to rip, the depth of such primarily cellulose embodiments is desirably less, such that preferably, the elongated embossments 24 are on most or all filter media pack pleat panels 20 to use the depth of embossments 24 to maximize pleat spacing that can be accomplished while not ripping due to embossment formation.

With this in mind, in the embodiments, the elongated embossments 24 comprise a maximum depth 54 of between 1.0 and 4.5 millimeters, with the higher end typically more suitable for primarily polymer based filter media blends. More preferably maximum embossment depth is between 1.0 and 2.0 millimeters and most preferably between 1.3 and 1.6 millimeters (especially for primarily cellulose blends such as 80/20 cellulose media).

While additional adhesive supports can be used in some embodiments, such adhesives add cost, weight and block filter media reducing filtration capacity. Accordingly, with the elongated embossments 24 in combination with at least one additional structural feature (e.g., saddles 30, or offset alignment 32, or bridge embossments 34, or angled alignment 36), preferably no adhesives are applied internally of any of the pleated filter media pack 10, 110, 210, 310, 410, 510 between panels 20 of the filter media sheet 12. However, adhesives such as sealants are typically applied to and proximate the perimeter of the filter media pack such as along side edges 48 to facilitate closure of the sides of flutes or over a flow face (e.g., hot-melt support beads applied to a flow face), but either of these would not be considered “internally of the pleated filter media pack” as it is along the periphery.

The elongated embossments 24 have a lateral span 56 that can vary from embodiment to embodiment or even within an embodiment such as at the saddle region as shown in FIGS. 10 and 11. The embossment's lateral span 56 can be measured perpendicularly relative to the longitudinal extension of the elongated embossments 24. While not be limited thereto as wider embossments are possible, in many applications and embodiments, the lateral span 56 of the elongated embossments 24 will be between 2 and 6 millimeters. It is also seen in the various embodiments that typically the lateral span 58 of the unembossed/flat regions 26 are greater than the lateral span 56 of the elongated embossments 24. Stated another way, the unembossed/flat regions 26 are preferably wider than the elongated embossments 24.

Wider unembossed/flat regions 26 as compared to elongated embossments 24 can have the advantage that much of the filtration characteristics of the original filter media sheet 12 remain unchanged (e.g., reduced need to stretch/compress in the unembossed/flat regions 26), and the flat regions allow for more ready formation and stretch of the embossments 24. Wider unembossed/flat regions 26 also provide larger volume inlet and outlet flow channels 28, 29. Therefore, preferably, the lateral span of the un-embossed/flat regions 26 at least 200%, more preferably between 200% and 600%, and most preferably between 225% and 325% of the lateral span 56 of each of the elongated embossments 24.

Another common feature for the first three groups of the illustrated embodiments, and in particular the filter media packs 10, 110, 210 of FIGS. 1-24 is that all of the elongated embossments 24 face the same direction in the pleated filter media pack 10, 110, 210. This is realized in that the pleated filter media packs 10, 110, 210 having successively alternating first and second panels 20A, 20B, with the elongated embossments 24 on first panels 20A projecting outwardly from a first side face 60 of the filter media sheet 12, and the elongated embossments 24 on second panels 20B projecting outwardly from a second side face 62 of the filter media sheet 12 opposite the first side face 60.

In contrast, as shown in the filter media pack 310 of the angled alignment embodiment of FIGS. 25-31, the elongated embossments 24 face opposite directions rather than the same direction (e.g., half of the embossments 24 face one direction and half of the embossments face the other direction).

Turning now in greater detail to individual embodiments, FIGS. 1-15 demonstrate elongated embossments 24 with saddles 30. The saddles 30 are illustrated to provide a variable height embossment profile included alternating peaks 70 and valleys 72. These saddles 30 can provide various potential advantages including any one or more of the following: enhanced structural rigidity to the embossments and the filter media sheet, reduce blinding off as between pleat panels, or prevent/reduce relaxing of the media perpendicular to the direction of the embossments.

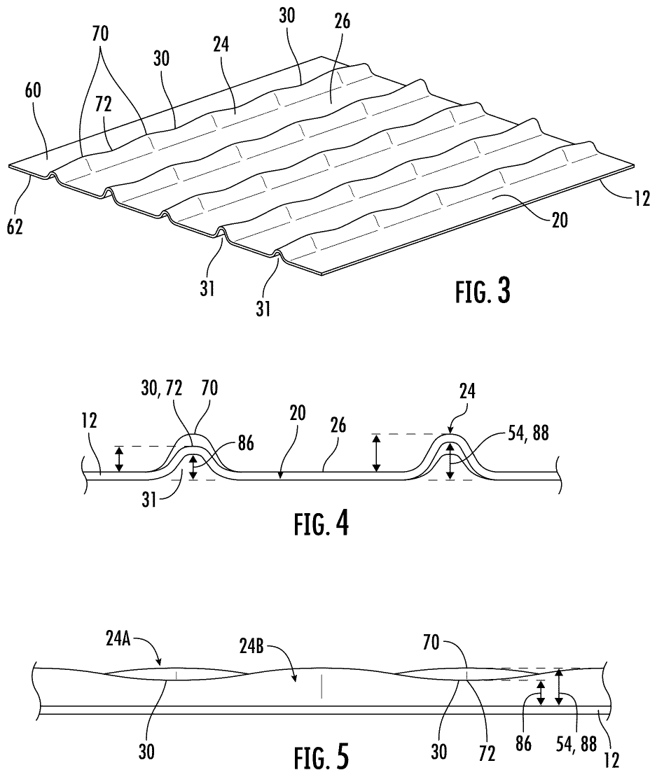

As shown in FIGS. 5, and 12-14, these peaks 70 and valleys 72 may follow a sinusoidal path with a repeating period 74. The period 74 of the sinusoidal path has an offset 74 as between adjacent elongated embossments 24A, 24B such that the peaks 70 of a first elongated embossment 24A coincide laterally with the valleys 72 of a second elongated embossment 24B that is adjacent to the first elongated embossment 24A.

As shown in FIGS. 5, and 12-14 the period 74 may be offset by between ¼ and ¾. For example, in FIG. 13 there is a ¼ offset 76 to the period 74; and in FIGS. 13 and 14 there is a ½ offset 76 to the period 74.

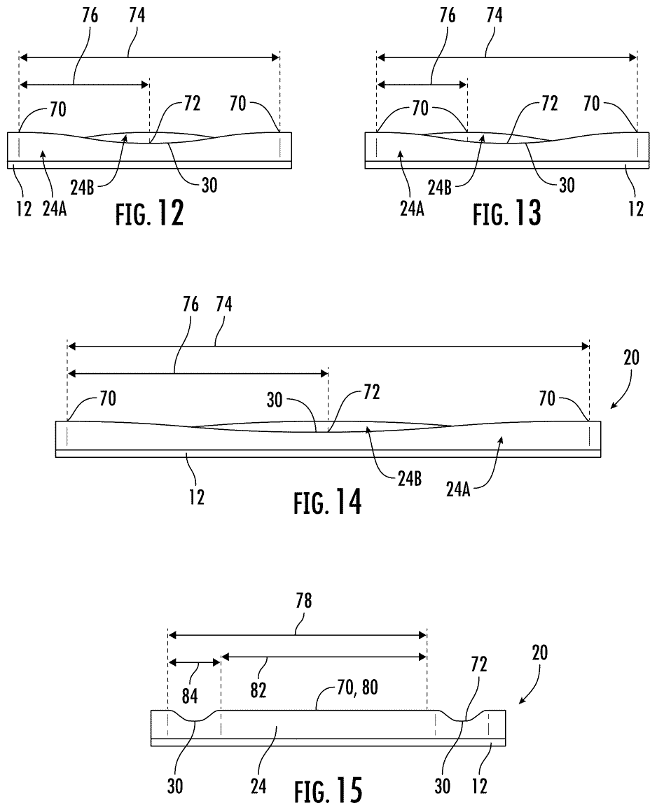

FIG. 14 also shows relative to FIG. 12 that the period 76 may be longer or shorter. For example, one saddle is provided periodically every 2 to 8 centimeters to facilitate enhanced anti-blinding effects while maintaining rigidity features.

Alternatively, as shown in FIG. 15, the saddles 30 follow repeating period 78 in a non-sinusoidal path. In the FIG. 15 embodiment, the peaks are in the form of elongated ridges 80 extending between adjacent saddles 30. In such design, preferably, the elongated ridges 80 have a longitudinal span 82 that is at least 50% greater than a longitudinal span 84 of the saddles, preferably between 50% and 300% of the longitudinal span 84 of the saddles.

As is the case and similar to that of FIGS. 12-14, in FIG. 15, the period 78 of the non-sinusoidal path can be offset as between adjacent elongated embossments (not shown in FIG. 15) such that the peaks of a first elongated embossment coincide laterally with the valleys of a second elongated embossment that is adjacent to the first elongated embossment. This increases rigidity as potential pivot points that may be created by saddle regions do not coincide but are offset providing rigidity to pleat panels.

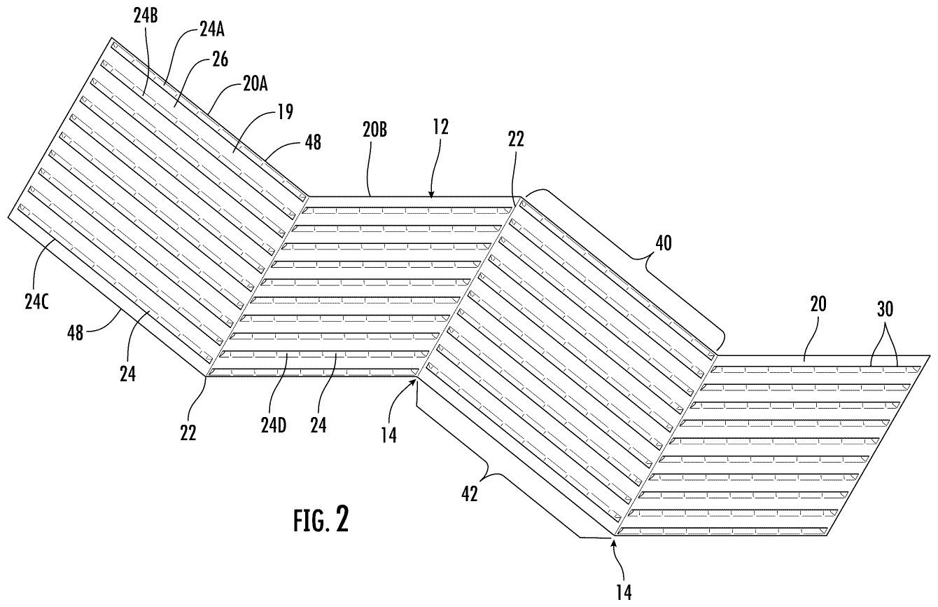

It is understood that any of the saddle profiles used in FIGS. 12-15 may be employed in the filter media pack 10 and sheet 12 of FIGS. 1 and 2.

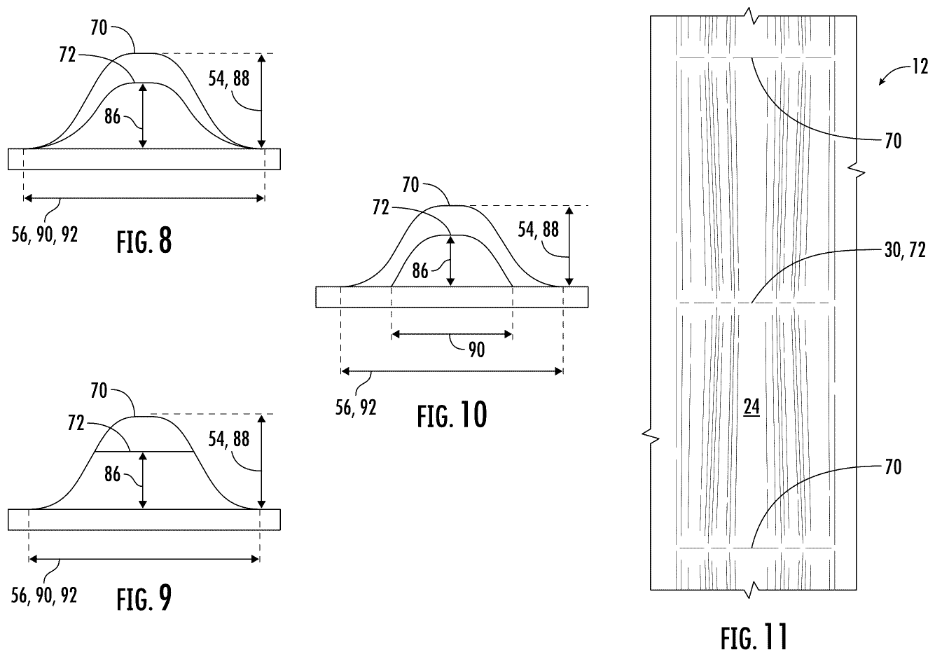

Turning to FIGS. 8-11, the configuration of any of the saddles can also be squished as shown in FIG. 8, chopped as shown in FIG. 9, or translated as shown in FIG. 10-11. For example, as shown in FIGS. 8 and 9, the base of the saddles 30 can have the same lateral width as the peaks 70; or may have a narrower translated width as shown in FIGS. 10-11. Any of these profiles may be used for any of the profile embodiments of FIGS. 12-15.

As in FIG. 8, the embossment profile is squished such that the height changes, while the base width remains the same. Alternatively in FIG. 9, the embossment profile is chopped from the top of the peak, maintaining base dimensions of the original embossment profile. As a further alternative, the embossment profile can be translated as shown in FIGS. 10-11, in which the embossment profile is translated downward, changing the base width.

In the various embodiments, the saddles provide the valleys 72 between adjacent peaks 70. The elongated embossments 24 may have a minimum depth 86 at the valleys 72 that is between 25% and 75% of a maximum depth 88 at the peaks 70 (more preferably the minimum depth 86 is between 35% and 65% of the maximum depth 88). Maximum depth 88 is considered the same as embossment depth 54. It is noted for example as in FIG. 8 that in measuring the minimum depth 86, such measurement should be done at the apex (e.g., at the center for symmetrical end profile as shown in FIG. 8). Also, assuming the filter media sheet thickness remains constant (i.e., not compressed/expanded), the depths 86, 88 (e.g., 54) can be measured from the top surface of the sheet (to measure embossment height to the top of the embossment) or measured from the bottom surface of the sheet 12 (to the bottom of an embossment trough) as shown in FIG. 4, as the thickness of the sheet 12 makes these the same measurements.

As shown in FIGS. 10-11, optionally the embossments 24 can vary in lateral width span 56 with a minimum lateral width span defined at the valleys and maximum lateral width span defined at the peaks. The minimum lateral width span 90 is between 50% and 100% of the maximum lateral width span 92 (e.g., typically the same as embossment lateral span 56), and if laterally varied the minimum lateral width span is more preferably between 60% and 85% of the maximum lateral width span. As shown in FIGS. 10, 11, lateral span 92 can measure along the base (the face surface) of the sheet from which the embossment projects above.

Referring next to the offset alignment embodiment of FIGS. 16, 18 and 19, offset alignment 32 of elongated embossments 24 are illustrated. Offset alignment 32 adds structural rigidity to the filter media pack 110 by shortening the “beam” along the unembossed/flat regions 26 to prevent pack collapse when subjected to high differential gas pressure. Such offset alignment 32 moves the point of force of embossment contact to a geometrically stronger location. This can be best seen in comparing FIGS. 16 and 17, in which FIG. 17 illustrates the absence of offset alignment features for comparison.

FIG. 17 illustrates the typical symmetrical elongated embossment offset used in the varied height embodiments of FIGS. 1-15 and the bridge embossment embodiments of FIGS. 20-24. In the typical symmetrical elongated embossment offset, the elongated embossments 24 on first panels 20A are arranged to contact at midpoint between elongated embossments 24 of the second panels 20B (e.g., along the unembossed-flat regions or bridge-embossments contained therein); and the elongated embossments 24 on second panels 20B are arranged to contact at midpoint between elongated embossments 24 of the first panels 20A (e.g., along the unembossed-flat regions or bridge-embossments contained therein).

As shown in comparison FIGS. 16 and 17, in the non-symmetrical configuration of FIG. 16 (offsetting the contact from the midpoint between embossments 24), the effective fulcrum point is moved away from the midpoint of the unembossed/flat regions 26. This can provide less deflection, as shown with the flexing of the filter media sheet as idealized/represented with dashed lines in FIGS. 16 and 17 (assumes similar loads/forces applied). In particular, by being closer to the elongated embossment of the adjacent pleat panel there is less opportunity to bend in the unembossed/flat regions 26 as shown in FIG. 16 as compared with that of FIG. 17.

As shown, FIGS. 16, 18 and 19 achieve the offset alignment 32 with a first set of the elongated embossments 24C of first panels 20A, and a second set of the elongated embossments 24D of second panels 20B that project in a common direction as the first set (e.g., on different adjacent pleat panels that may repeat). The first set of the elongated embossments 24C engage respective regions of the un-embossed/flat regions 26 of the second panels 20B at a location offset from a lateral midpoint 96 defined between respective adjacent embossments 24D of the respective regions of the un-embossed/flat regions 26 of the second panels 20B.

Likewise, the second set of the elongated embossments 24D engage respective regions of the un-embossed/flat regions 26 of the first panels 20A at a location offset from a lateral midpoint 96 defined between respective adjacent embossments 24C of the respective regions of the un-embossed/flat regions 26 of the first panels 20A.

Recalling that the un-embossed/flat regions 26 extend the lateral span 58 between adjacent elongated embossments 24 on each panel, the lateral midpoint 96 is midway therebetween and located at 50% of the lateral span 58 of the un-embossed/flat regions 26 (e.g., along locations perpendicular to the longitudinal direction of the elongated embossments). To maximum benefits mentioned above, the first set of elongated embossments 24C engage at a location that is between 0% and 30% of the lateral span 58 (i.e., at least 20% away from the midpoint), and more preferably between 5% and 20% of the lateral span 58 of the un-embossed/flat regions 26.

This is particularly useful in larger lateral spans of un-embossed/flat regions 26 in which the filter media, with wider lateral spans of un-embossed/flat regions 26, substantial portions may not be structurally formed/enhanced and thereby substantially retain original filtration characteristics of the filter media sheet 12. Also, wider flow channels may be realized. For example, the span of the un-embossed/flat regions is at least 200% greater than a maximum width, with the lateral span of the un-embossed/flat regions preferably being between 200% and 600% of the maximum width of the elongated embossments.

Turning next to bridge embossment embodiment of FIGS. 20-24, additional details of bridge embossments 34 will be discussed. The bridge embossments 34 add structural rigidity in a different direction than the direction in which the elongated embossments 24 extend longitudinally. Bridge embossments 34 add structure to the un-embossed/flat regions 26 between embossments 24 supporting the filter media pack 210 against collapse under high differential gas pressure when in use. Bridge embossments 34 can also reduce blinding off and provide more intermittent contact points between the embossment tips and the flat section similar but in a different manner than that of the variable height embossments.

Typically, the bridge embossments 34 extend laterally greater than 50% of a lateral span (e.g., the unembossed flat region lateral span 58) between adjacent members of the elongated embossments 24A, 24B, and preferably between 70% and 110% of the lateral span 58 (the bridge embossments may extend slightly greater than the span as the bridge embossments 34 merge into the region of the elongated embossments 24 as shown). Most preferably, the bridge embossments span entirely across the un-embossed/flat regions connecting adjacent members of the elongated embossments to maximize structural rigidity and avoiding a bending region of the filter media sheet between embossments.

As shown in FIGS. 20-24 preferably all of the un-embossed/flat regions 26 have bridge embossments 34 formed therein. However, it is not necessary for all un-embossed/flat regions 26 to have such bridge embossments 34 formed therein, and benefit can be realized if some of the embossed/flat regions 26 have bridge embossments.

Typically, at least 75% and preferably 90%-100% of the un-embossed/flat regions between adjacent members of the elongated embossments.

Also, preferably, all of the panels 20 (e.g., adjacent panels 20A, 20B) having the elongated embossments have such bridge embossments 34 but again benefits can be realized even if alternating panels have such bridge embossments 34.

The bridge embossments 34 may project the same direction as embossments on each panel and still provide rigidity benefits, but more preferably project in opposite direction along each panel 20 to enhance intermittent contacts as shown in FIGS. 20-24. The bridge embossments 34 and the elongated embossments 24 project outwardly from opposite side faces 60, 62 of the filter media sheet 12, respectively.

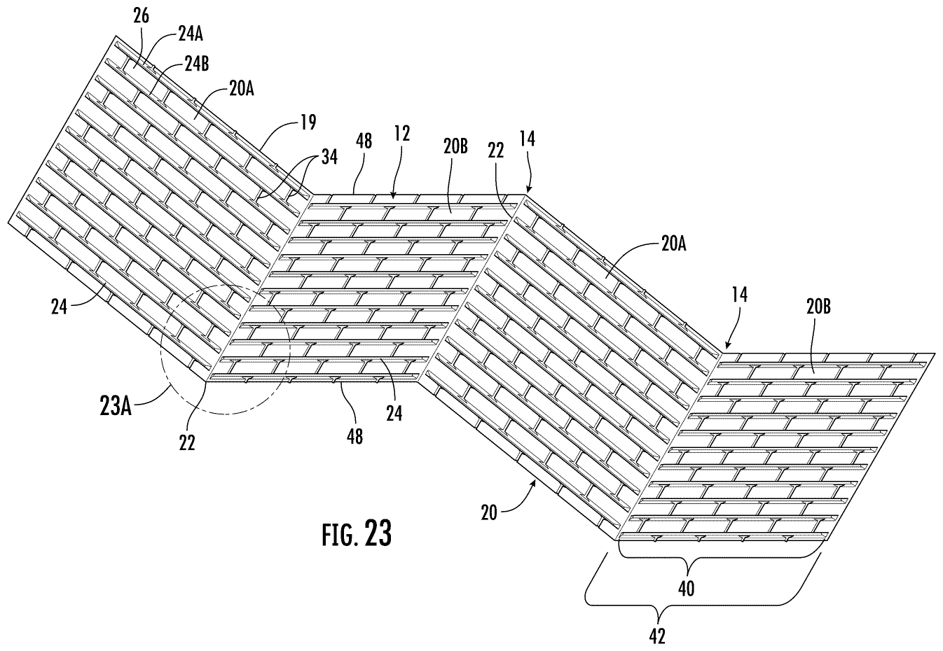

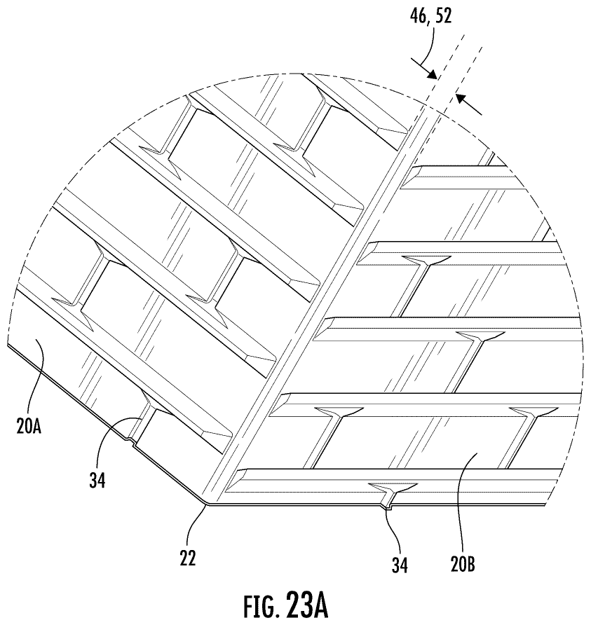

Furthermore, to align the elongated embossments 24 in a common direction when folded into the filter media pack 210, such as shown in FIG. 21, bridge embossments 34 project from one side face on some panels 20A and also bridge embossments 34 project from the other side face on the other panels 20B. This is better shown in FIG. 23A. Thus, bridge embossments 34 can project in opposite directions when formed into the filter media sheet (e.g., in the filter media sheet lying upon a flat surface after formation, some bridge embossments 34 project upward above the top surface 60 of the filter media sheet 12 and some bridge embossments 34 project downward below the bottom surface 62 of the filter media sheet 12).

In particular, as shown in FIG. 21 and FIG. 24, all of the elongated embossments 24 face the same direction in the pleated filter media pack 210, with pleated filter media pack 24 having successively alternating first and second panels 20A and 20B. With additional reference to the enlarged view of FIG. 23A, it can be seen that the elongated embossments 24 on first panels 20A project outwardly from the first side face 60 (e.g., top sheet surface during forming via roll or flat press dies) of the filter media sheet 12, and the elongated embossments 24 on second panels 20B projecting outwardly from the second side face 62 (e.g., bottom sheet surface during forming via roll or flat press dies) of the filter media sheet 12 opposite the first side. The bridge embossments 34 project the opposite direction from the elongated embossments on individual panels 20. In particular, the bridge embossments 34 on the first panels 20A project outwardly from the second side face 62 of the filter media sheet 12 (e.g., from the bottom sheet surface during forming via roll or flat press dies), and the bridge embossments 34 on the second panels 20B project outwardly from a first side face 60 of the filter media sheet 12 (e.g., project from the top sheet surface during forming via roll or flat press dies).

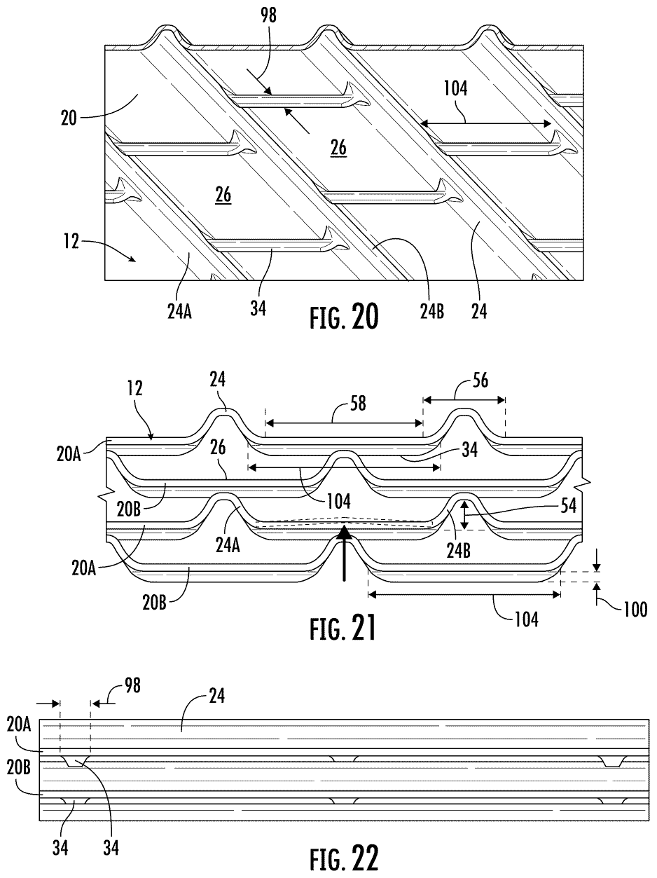

In additional to providing bridge strength, intermittent contact and lifting off the elongated embossments 24 can be accomplished with the bridge embossments 34. In the assembled pleated filter media pack 210, and as best shown in FIG. 21 (see also FIG. 22), the elongated embossments 24 on the first panel 20A contact the bridge embossments 34 of the second panel 20B that is adjacent to the first panel 20A. This can lift the majority of the ridges of the elongated embossments 24 off the un-embossed/flat regions 26 of the filter media sheet 12.

The bridge embossments 34 are also relatively shallow so as not to impeded airflow in the inlet and outlet flow channels 28, 29. The bridge embossments 34 may also not be that wide either so as to maximize unformed remainder regions of the unembossed/flat regions 26. For example, the bridge embossments define a bridge width 98 and a bridge depth 100 (same measurement as bridge height) as shown in FIGS. 21 and 22, in which: (a) the bridge width 98 may be between and 10% and 50% of a maximum width (i.e., embossment lateral span 56) of the elongated embossments 24, and more preferably between 20% and 40% of the maximum width of the elongated embossments 24; and the bridge depth is between 10% and 50% of a maximum depth of the elongated embossments, and more preferably between 20% and 40% of the maximum depth of the elongated embossments.

For example, the bridge width 98 may be between 1 and 3 millimeters, more preferably between 1 and 2 millimeters. The bridge length 104 preferably is the same or closely matches that of the un-embossed/flat region lateral span 58 (typically minimally/slightly greater as the bridges may enter into the span of the elongated embossments or rise up onto the slopes of the elongated embossments 24 as shown in FIGS. 20 and 21) to fully span between adjacent elongated embossments, for example the lateral span 58 and bridge length 104 can typically be between 4 and 36 millimeters, and more preferably between 8 and 20 millimeters. Also, for example, a maximum bridge embossment depth may be between 0.2 and 1.0 millimeters, and more preferably between 0.3 and 0.8 millimeters.

In the above paragraph, the bridge length 104 of the bridge embossments 34 is measured perpendicular to the elongated embossments 20, because the bridge embossments 34 as shown extend perpendicularly to the elongated embossments 20. It is contemplated that the bridge embossments may alternatively extend at an oblique angle relative to the elongated embossments 20 in which instance the actual bridge length if spanning the entire distance between elongated embossments 24 would be substantially greater than the un-embossed/flat region lateral span 58. Thus, in some embodiments with obliquely angled bridge embossments, instead of bridge length 104, bridge span may be a better term for describing as bridge span envisions measuring the span of the embossment bridges perpendicularly between embossments regardless of whether the bridge embossments extend perpendicular or obliquely (e.g., bridge embossment span preferably is the same or closely matches that of the un-embossed/flat region lateral span 58). Accordingly, the term bridge length/span may be used to encompass either perpendicularly or obliquely extending bridge embossments and in which the measurement is the span perpendicularly between elongated embossments (thereby indicating how much lateral span between elongated embossments is covered).

Another feature shown is that a pair of formed gussets 102 integrally connect the bridge embossments 36 with the elongated embossments 24, at the intersections thereof thereby enhancing structural support/rigidity and providing a smooth transition and merger therebetween.

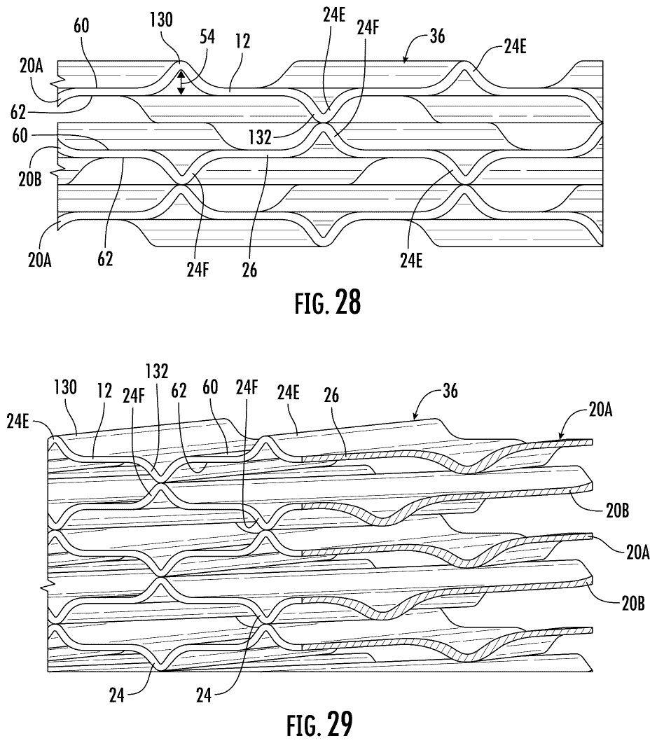

Turning next to FIGS. 25-31, this embodiment of the filter media pack 310 has the embossment enhancement as the angled alignment 36 of the elongated embossments 24, wherein the elongated embossments 24 extend at an oblique angle relative to the pleat folds 14. This provides intermittent contact locations between embossment 24 lifted away from un-embossed/flat regions 26 as shown best in FIGS. 28-29. For example, touch-off points prevent nesting of embossments while reducing blinding off of media. Further there may be speculative effects of turbulent air flow created from alternating flow path creating a “scavenging” effect within the media pack.

The angled elongated embossments 24 do not extend through the pleat folds 14 and instead stop short of the pleat folds 14 due to the creasing regions 46 provided.

Angled embossing can also facilitate more easily a continuous embossing process such as with cooperating rolls, and score lines and creasing regions 46 for folding could be made after embossments are made. Separating embossing and scoring would allow for customization of pleat height without significant tool costs. Additionally, if rolls are used to create continuous embossments in the sheet 12, a secondary step of flatting a portion and scoring periodically to creasing regions 46 (thereby undoing small segment portions of the continuous embossing) can be done.

Considering axial flow is maintained in this filter media pack 310 between inlet and outlet flow faces 16, 18, the angle of the elongated embossments typically should be less than 45 degrees. For example, according to the angled alignment 36, the elongated embossments project an oblique angle 106 relative to the pleat folds that is between 2 and 10 degrees, and more preferably between 3 and 8 degrees, most preferably about 5 degrees.

Preferably, the elongated embossments 24 extend linearly according to the angled alignment 36, but the angled alignment 36 encompasses curved profiles as well, in which the tangent of curvature can be oblique relative to pleat folds 14.

Furthermore, the elongated embossments 24 are formed into the filter media sheet in a common slanted direction as shown best in FIG. 31, wherein in the folded arrangement (see FIGS. 28-29 and 30), the elongated embossments 24E, 24F on adjacent panels 20A, 20B are angled in opposite slanted directions as shown therein. For example, embossments 24E extend in one slanted direction on first panels 20A, and embossments 24F on second panels 20B extend another direction once folded and compacted into the filter media pack 310.

For example, at least a set of (and preferably all) of the elongated embossments 24 with the angled alignment 36 can be formed into the filter media sheet 12 parallel with each other as shown in FIG. 31, such that the elongated embossments 24 on adjacent panels are angled in opposite directions.

As shown and apparent to one of ordinary skill, other than the outermost end panels of a filter media pack, first panels 20A are adjacent two second panels 20B and therefore sandwiched between a pair of adjacent second panels 20B. Similarly, second panels 20B are adjacent two first panels 20A and therefore sandwiched between a pair of adjacent first panels 20A.

One way to provide intermittent contact locations with the angled alignment 35 of the elongated embossments 24 is to provide a first array 130 of the elongated embossments 24 that are projecting outwardly from the first side face 60 (e.g., top surface of filter media sheet of the filter media sheet 12), and a second array 132 of the elongated embossments 24 that are projecting outwardly from the second side face 62 (e.g., bottom surface of filter media sheet of the filter media sheet 12) opposite of the first side face 60. With this configuration of oppositely projecting embossment arrays 130, 132, and with the embossments 24 (e.g., at least a set or all) being angled in a common direction as formed into the filter media sheet 12, when assembled into the filter media pack 310 via the pleat folds 14, the elongated embossments 24 on alternating adjacent panels 20A, 20B are angled in opposite directions relative to each other as shown in FIGS. 28-30.

This feature of oppositely projecting embossment arrays 130, 132 are particularly useful when used alone to create intermittent contact points as shown in this filter media pack 310. Furthermore, additional features could be used in the filter media pack 310 such as at least one the saddles 30 and bridge embossments 34 in combination. In this filter media pack 310 with oppositely projecting embossment arrays 130, 132.

Without oppositely projecting embossment arrays 130, 132, the offset alignment 32 feature may more easily be used in combination. For example, while not shown, elongated embossment 24 when formed in the angled alignment 36 may be formed only project from either one of the side faces 60, 62 (e.g., top or bottom surface during stamping the filter media sheet 12 with a roll or plate press), which may be used in connection with a combination with other features (e.g., bridge embossments 34 to provide intermittent contact and offset alignment 32). Additionally, saddles 30 used in combination with angled alignment to create intermittent contact locations.

Additional embodiments having combinations of embossment enhancement features are shown in the filter media packs 410, 510, the features used in these are the same as used in the prior filter media packs 10, 110, 210, just according to different combinations as indicated Table 1 above. Accordingly, discussion of these will be limited to the combinations of such features previously disclosed and discussed already in detail.

For example, in the filter media pack 410 of FIGS. 35-36, the filter media sheet 12 is formed with a combination of saddles 30 (variable embossment height) and offset alignment 32 features. The advantages and discussion about configuration the saddles 30 (variable embossment height) feature described in relation to FIGS. 1-15 are also applicable to this embodiment; and similarly, the advantages and discussion about configuration the offset alignment 32 feature described in relation to FIGS. 16-19 are also applicable to this embodiment. The combination of saddles 30 and offset alignment 32 may also work synergistically with each other to both provide structural rigidity in multiple directions and intermittent contacts at the same time.

As another example, in the filter media pack 510 of FIGS. 37-38, the filter media sheet 12 is formed with a combination of saddles 30 (variable embossment height) and the offset alignment 32 and bridge embossments 34. The advantages and discussion about configuration the saddles 30 (variable embossment height) feature described in relation to FIGS. 1-15 are also applicable to this embodiment; and similarly, the advantages and discussion about configuration the offset alignment 32 feature described in relation to FIGS. 16-19 are also applicable to this embodiment; and similarly, the advantages and discussion about configuration the bridge embossments 34 feature described in relation to FIGS. 20-24 are also applicable to this embodiment. The combination of saddles 30 and offset alignment 32 and bridge embossments 34 may also work synergistically with each other to both provide structural rigidity in multiple directions and intermittent contacts at the same time.

### Additional Observations/Embodiments

Additional/embodiments discussed below are intended to be covered by the claimed appended hereto unless clearly indicated otherwise.

In the various filter media packs 10, 110, 210, 310, 410, 510, the inlet flow face 16 comprises a planar configuration, and the outlet flow face 18 comprises a planar configuration, and preferably the inlet flow face 16 is co-planar with the outlet flow face 18. However, other possibilities with non-planar or non-co-planar may be done in some embodiments of the present invention.

Additionally, embossments 24 and the features 30, 32, 34, 36 are shown on each of the pleat panels 20, which is easiest from a processing and benefit perspective. However, it is not necessary that all pleat panels 20 include embossments 24. It is not necessary that all pleat panels 20 include one or more of the features 30, 32, 34, 36. It is understood that unless “all” of the panels is stated that fewer than all of the panels may include embossments 24 and one or more of the features 30, 32, 34, 36. Typically substantially all (i.e., at least 80% of the panels 20) of the pleated filter media pack have the elongated embossments formed therein for greatest advantage. Sometimes, the outer most panels might not need such embossments or embossment enhancements as those may be mounted to a sealing system and/or mounting frame in use with a filter cartridge.

Additionally, in some embodiments the embossments 24 and the features 30, 32, 34, 36 might be on alternating panels, which may be the case if flat panels are used for first panels and embossments are used on second panels.

The filter media packs are useful in an air filter cartridge comprising one of the pleated filter media packs 10, 110, 210, 310, 410, 510. For example, the pleated filter media packs 10, 110, 210, 310, 410, 510 could be employed in the air filter and with sealing systems or mounting frames such as shown in US20220126227A1 to Krull et al., entitled Gasket And Frame Assembly For Air Filter, which is hereby incorporated by reference in that any of the filter media packs disclosed herein may be substituted for that US20220126227A1 to Krull et al. As will be understood with reference thereto, a filter cartridge can be provided comprising a housing seal mounted to the pleated filter media pack 10, 110, 210, 310, 410, 510 and optionally a seal support for mounting of the housing seal.

Additionally, while the above embodiments are described as useful with substantial advantages for pleated filter media packs 10, 110, 210, 310, 410, 510, it will be understood that the various embossment enhancement features (saddles 30, offset alignment 32, bridge embossments 34 and angled alignment 36) disclosed herein may be used with other types of media packs beside pleated such as stacked fluted media panels and fluted filter media packs as those disclosed and described in U.S. Pub. No. 2014/0260139 entitled Rectangular Stacked Fluted Filter Cartridge to Merritt which is incorporated by reference in its entirety (e.g., see FIG. 26 thereof with cut panels that are stacked and sealed with end adhesive beads). The advantages herein of various embossment enhancement features are not as needed in such designs as structural integrity is provided by adhesive end seal beads (and perhaps tack beads) that provide self-supporting block. Further, such alternative embodiments of the present invention are not as preferred as end sealant beads provide for the possibility of leakage paths in individual flutes between cut sheets, and also reduce filtration capacity. Nevertheless, and as such certain broader claims (for example claims that do not explicitly require pleats or pleated) that are appended hereto are meant to encompass such possibilities of such stacked fluted media panels and fluted filter media packs as some benefit may be realized in such alternative embodiments.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A pleated filter media pack, comprising:
a filter media sheet folded along pleat folds at an inlet flow face and pleat folds at an outlet flow face to provide a plurality of pleats with panels extending between the inlet flow face and the outlet flow face;
a plurality of elongated embossments formed into the filter media sheet and extending longitudinally between the inlet flow face and the outlet flow face, the elongated embossments spaced laterally apart and separated laterally by un-embossed/flat regions; and
at least one feature comprising any one or more of the following:
(a) saddles formed into the elongated embossments that are raised relative to the un-embossed/flat regions; or
(b) offset alignment of the elongated embossments comprising a first set of the elongated embossments of first panels, and a second set of the elongated embossments of second panels that project in a common direction as the first set, wherein the first set of the elongated embossments engage respective regions of the un-embossed/flat regions of the second panels at a location offset from a lateral midpoint defined between respective adjacent embossments of the respective regions of the un-embossed/flat regions of the second panels; or
(c) bridge embossments formed into the un-embossed/flat regions that extend laterally between adjacent members of the elongated embossments; or
(d) angled alignment of the elongated embossments, wherein the elongated embossments extend at an oblique angle relative to the pleat folds and with intermittent contact locations.

2. The pleated filter media pack of claim 1, wherein the elongated embossments extend between 75% and 99% of a span of the panels between the inlet flow face and the outlet flow face.

3. The pleated filter media pack of claim 1, wherein creasing regions extend transversely between opposed edges of the filter media sheet, and wherein the creasing regions have a width parallel to the opposed edges spanning between 0.1 and 3.0 centimeter, and wherein at least one score line is formed in each creasing region thereby to facilitate the pleat folds, and wherein the elongated embossments reside outside of the creasing regions and taper toward the creasing regions at opposite ends of the elongated embossments.

4. The pleated filter media pack of claim 3, wherein all of the elongated embossments extend continuously an entire span between the creasing regions at opposite ends of the elongated embossments.

5. The pleated filter media pack of claim 1, wherein the panels extend a span between the inlet flow face and the outlet flow face between 7 and 45 centimeters.

6. The pleated filter media pack of claim 1, wherein the filter media sheet comprises cellulose fibers, synthetic polymer fibers, or glass fibers.

7. The pleated filter media pack of claim 6, wherein the filter media sheet comprises a blend of fibers comprising the cellulose fibers and the synthetic polymer fibers, wherein the blend of fibers comprises by weight percentage greater than 50% cellulose fibers; and more preferably between 70%-90% cellulose fibers and 10%-30% synthetic polymer fibers; and most preferably between 75%-85% cellulose fibers and 15%-25% synthetic polymer fibers.

8. The pleated filter media pack of claim 1, wherein no adhesives are applied internally of the pleated filter media pack between panels of the filter media sheet.

9. The pleated filter media pack of claim 1, wherein the elongated embossments comprise a maximum depth of between 1.0 and 4.5 millimeters.

10. The pleated filter media pack of claim 1, wherein within an internal region of the pleated filter media pack, the lateral span of the un-embossed/flat regions is at least 200%.

11. The pleated filter media pack of claim 1, wherein all of the elongated embossments face the same direction in the pleated filter media pack, the pleated filter media pack having successively alternating first and second panels, wherein the elongated embossments on first panels projecting outwardly from a first side face of the filter media sheet, and the elongated embossments on second panels projecting outwardly from a second side face of the filter media sheet opposite the first side face.

12. The pleated filter media pack of claim 1, wherein the at least one feature provides both bridge strength laterally between embossments and intermittent contact points.

13. The pleated filter media pack of claim 1, wherein the at least one feature comprises at least two features selected from the following group: (a) the saddles, (b) the offset alignment, and (c) the bridge embossments.

14. The pleated filter media pack of claim 13, wherein the at least one feature comprises all of: (a) the saddles, (b) the offset alignment, and (c) the bridge embossments.

15. The pleated filter media pack of claim 1, wherein the at least one feature comprises the angled alignment of the elongated embossments, in which a first array of the elongated embossments are projecting outwardly from a first side face of the filter media sheet and second array of the elongated embossments are projecting outwardly from a second side face of the filter media sheet opposite of the first side face.

16. The pleated filter media pack of claim 1, wherein the at least one feature comprises at least the saddles, and wherein the elongated embossments comprise a variable embossment profile included alternating peaks and valleys following a sinusoidal path with a repeating period, and wherein a period the sinusoidal path is offset as between adjacent elongated embossments such that the peaks of a first elongated embossment coincide laterally with the valleys of a second elongated embossment that is adjacent to the first elongated embossment.

17. The pleated filter media pack of 16, wherein the period is offset by between ¼ and ¾.

18. The pleated filter media pack of claim 1, wherein the at least one feature comprises at least the saddles, and wherein the saddles follow repeating period in a non-sinusoidal path.

19. The pleated filter media pack of claim 18, wherein peaks in the form of elongated ridges are between adjacent saddles, the elongated ridges having a longitudinal span that is at least 50% greater than a longitudinal span of the saddles.

20. The pleated filter media pack of claim 18, wherein a period the non-sinusoidal path is offset as between adjacent elongated embossments such that the peaks of a first elongated embossment coincide laterally with the valleys of a second elongated embossment that is adjacent to the first elongated embossment.

21. The pleated filter media pack of claim 1, wherein the at least one feature comprises at least the saddles, the saddles providing valleys between adjacent peaks, wherein the elongated embossments have a minimum depth at the valleys that is between 25% and 75% of a maximum depth at the peaks.

22. The pleated filter media pack of claim 1, wherein the at least one feature comprises at least the saddles, the saddles providing valleys between adjacent peaks, and wherein the elongated embossments optionally vary in lateral width span with a minimum lateral width span defined at the valleys and maximum lateral width span defined at the peaks, wherein the minimum lateral width span is between 50% and 100% of the maximum lateral width span, and if laterally varied the minimum lateral width span is between 60% and 85% of the maximum lateral width span.

23. The pleated filter media pack of claim 1, wherein the at least one feature comprises at least the saddles, and wherein one saddle is provided periodically every 2 to 8 centimeters.

24. The pleated filter media pack of claim 1, wherein the at least one feature comprises at least the offset alignment, wherein the un-embossed/flat regions extend a lateral span between adjacent elongated embossments on each panel with the lateral midpoint therebetween thereby located at 50% of the lateral span, wherein the first set of elongated embossments engage at a location that is between 0% and 30% of the lateral span.

25. The pleated filter media pack of claim 24, wherein lateral span of the un-embossed/flat regions is at least 200% greater than a maximum width of the elongated embossments.

26. The pleated filter media pack of claim 1, wherein the at least one feature comprises at least the bridge embossments, and wherein the bridge embossments extend laterally greater than 50% of a lateral span between adjacent members of the elongated embossments.

27. The pleated filter media pack of claim 26, wherein the bridge embossments span entirely across the un-embossed/flat regions connecting adjacent members of the elongated embossments.

28. The pleated filter media pack of claim 1, wherein the at least one feature comprises at least the bridge embossments, wherein and at least 75% of the un-embossed/flat regions have bridge embossments between adjacent members of the elongated embossments on all of the panels having the elongated embossments.

29. The pleated filter media pack of claim 1, wherein the at least one feature comprises at least the bridge embossments, wherein on each panel, the bridge embossments and the elongated embossments project outwardly from opposite side faces of the filter media sheet, respectively.

30. The pleated filter media pack of claim of claim 1, wherein all of the elongated embossments face the same direction in the pleated filter media pack, the pleated filter media pack having successively alternating first and second panels, wherein:
(a) the elongated embossments on first panels projecting outwardly from a first side face of the filter media sheet, and the elongated embossments on second panels projecting outwardly from a second side face of the filter media sheet opposite the first side face; and
(b) the bridge embossments on first panels projecting outwardly from the second side face of the filter media sheet, and the bridge embossments on second panels projecting outwardly from the first side face of the filter media sheet opposite the second side face.

31. The pleated filter media pack of claim 1, wherein the at least one feature comprises at least the bridge embossments, and wherein the elongated embossments on a first panel contact the bridge embossments of a second panel that is adjacent to the first panel.

32. The pleated filter media pack of claim 1, wherein the at least one feature comprises at least the bridge embossments, wherein the bridge embossments define a bridge width and a bridge depth, and wherein:
(a) the bridge width is between and 10% and 50% of a maximum width of the elongated embossments; and
(b) the bridge depth is between 10% and 50% of a maximum depth of the elongated embossments.

33. The pleated filter media pack of claim 1, wherein the at least one feature comprises at least the bridge embossments, further comprising a pair of formed gussets integrally connecting the bridge embossments with the elongated embossments.

34. The pleated filter media pack of claim 1, wherein the at least one feature comprises at least the bridge embossments, and wherein the bridge embossments are elongated bridge embossments defining a bridge length/span between the adjacent members of the elongated embossments, and a bridge width perpendicular thereto, wherein the bridge width is between 1 and 3 millimeters; and wherein the bridge length/span is between 4 and 36 millimeters; and wherein a maximum bridge embossment depth is between 0.2 and 1.0 millimeters.

35. The pleated filter media pack of claim 1, wherein the at least one feature comprises at least the bridge embossments and wherein all of the panels that include elongated embossments also include the bridge embossments.

36. The pleated filter media pack of claim 1, wherein the at least one feature comprises at least the angled alignment of the elongated embossments, and wherein the elongated embossments project an oblique angle relative to the pleat folds that is between 2 and 10 degrees.

37. The pleated filter media pack of claim 1, wherein the at least one feature comprises at least the angled alignment of the elongated embossments, and wherein the elongated embossments extend linearly.

38. The pleated filter media pack of claim 1, wherein the at least one feature comprises at least the angled alignment of the elongated embossments, and wherein the elongated embossments are formed into the filter media sheet in a common slanted direction, wherein in the folded arrangement, the elongated embossments on adjacent panels are angled in opposite slanted directions.

39. The pleated filter media pack of claim 38, wherein at least a set of the elongated embossments are formed into the filter media sheet parallel with each other.

40. The pleated filter media pack of claim 39, wherein all of the elongated embossments are formed into the filter media sheet parallel with each other.

41. The pleated filter media pack of claim 1, wherein the at least one feature comprises the angled alignment of the elongated embossments, in which a first array of the elongated embossments are projecting outwardly from a first side face of the filter media sheet and second array of the elongated embossments are projecting outwardly from a second side face of the filter media sheet opposite of the first side face, and wherein the embossments are angled in a common direction as formed into the filter media sheet such that with the pleat folds, the elongated embossments on adjacent panels are angled in opposite directions relative to each other.

42. The pleated filter media pack of claim 1, wherein the at least one feature comprises the angled alignment of the elongated embossments, and wherein each of the elongated embossments terminates short of the pleat folds, and linear score lines provide for the pleat folds.

43. The pleated filter media pack of claim 42, wherein the each of the elongated embossments is spaced from the pleat folds and thereby stop short of pleat folds.

44. The pleated filter media pack of claim 1, wherein the inlet flow face comprises a planar configuration, and the outlet flow face comprises a planar configuration, and preferably the inlet flow face is co-planar with the outlet flow face.

45. The pleated filter media pack of claim 1, wherein substantially all of the panels of the pleated filter media pack have the elongated embossments formed therein.

46. A filter cartridge comprising the pleated filter media pack of claim 1, comprising a housing seal mounted to the pleated filter media pack and optionally a seal support for mounting of the housing seal.

47. A filter media pack, comprising:
a plurality of panels of a filter media extending transversely between an inlet flow face and an outlet flow face, the plurality of panels arranged generally parallel and each having a first side face and a second side face opposite the first side face;
a plurality of elongated embossments formed into the panels and extending longitudinally between the inlet flow face and the outlet flow face, the elongated embossments spaced laterally apart and separated laterally by intermediate regions, each intermediate region between a respective pair of the elongated embossments; and
an offset alignment of the elongated embossments comprising a first set of the elongated embossments of first panels, and a second set of the elongated embossments of second panels that project in a common direction as the first set, wherein the first set of the elongated embossments engage respective regions of the intermediate regions of the second panels at a location offset from a lateral midpoint defined between respective adjacent embossments of the respective regions of the intermediate regions of the second panels.

48. The filter media pack of claim 47, wherein the plurality of panels are connected in a single continuous sheet that is folded into a pleated configuration, wherein the filter media pack is a pleated filter media pack.

49. The filter media pack of claim 47, wherein substantially all of the panels of the filter media pack have the elongated embossments formed therein.

50. The filter media pack of claim 47, wherein the second set of the elongated embossments engage respective regions of the intermediate regions of the first panels at a location offset from a lateral midpoint defined between respective adjacent embossments of the respective regions of the intermediate regions of the first panels.

51. The filter media pack of claim 47, wherein the intermediate regions extend a lateral span between adjacent elongated embossments on each panel with the lateral midpoint therebetween thereby located at 50% of the lateral span, wherein the first set of elongated embossments engage at a location that is between 0% and 30% of the lateral span.

52. The pleated filter media pack of claim 51, wherein lateral span of the un-intermediate regions is at least 200% greater than a maximum width of the elongated embossments, with the lateral span of the intermediate regions preferably being between 200% and 600% of the maximum width of the elongated embossments.

53. The filter media pack of claim 47, further comprising at least one feature in combination with the offset alignment, the at least one feature being any one or more of: (a) saddles formed into the elongated embossments; (b) bridge embossments formed into intermediate regions; or (c) angled alignment of the elongated embossments.

54. The filter media pack of claim 47, wherein the elongated embossments extend between 75% and 99% of a span of the panels between the inlet flow face and the outlet flow face, and wherein the panels extend a span between the inlet flow face and the outlet flow face between 7 and 45 centimeters.

55. The filter media pack of claim 47, wherein the filter media sheet comprises a blend of fibers comprising the cellulose fibers and the synthetic polymer fibers, wherein the blend of fibers comprises by weight percentage greater than 50% cellulose fibers; and more preferably between 70%-90% cellulose fibers and 10%-30% synthetic polymer fibers; and most preferably between 75%-85% cellulose fibers and 15%-25% synthetic polymer fibers.

56. The filter media pack of claim 47, wherein the elongated embossments comprise a maximum depth of between 1.0 and 4.5 millimeters.

57. The filter media pack of claim 47, wherein within an internal region of the filter media pack, the lateral span of the intermediate regions is at least 200%.

58. The filter media pack of claim 47, wherein all of the elongated embossments face the same direction in the filter media pack, the filter media pack having successively alternating first and second panels, wherein the elongated embossments on first panels projecting outwardly from a first side face of the filter media sheet, and the elongated embossments on second panels projecting outwardly from a second side face of the filter media sheet opposite the first side face.
